(19) United States
(12) Patent Application Publication
(10) Pub. No.: US 2016/0284075 A1
(43) Pub. Date: Sep. 29, 2016

(54) METHODS, APPARATUS, AND SYSTEMS FOR STRUCTURAL ANALYSIS USING THERMAL IMAGING

(71) Applicant: ESSESS, INC., Boston, MA (US)

(72) Inventors: Long Phan, Somerville, MA (US); Navrooppal Singh, Mullica Hill, NJ (US); Jonathan Jesneck, Enfield, CT (US); Jan Falkowski, Cambridge, MA (US); Ezekiel Hausfather, San Francisco, CA (US); William Morris, Somerville, MA (US); Thomas Scaramellino, New York, NY (US)

(21) Appl. No.: 15/174,073

(22) Filed: Jun. 6, 2016

Related U.S. Application Data
(63) Continuation-in-part of application No. 14/734,336, filed on Jun. 9, 2015.
Application No. 14/734,336 is a continuation of application No. PCT/US2013/031554, filed on Mar. 14, 2013.
(60) Provisional application No. 62/173,038, filed on Jun. 9, 2015.

(51) Int. Cl. G06T 7/00; G06T 7/60

(52) U.S. Cl. CPC G06T 7/001; G06T 7/602; G06T 7/0018; G06T 7/0022; G06T 2207/10048; G06T 2207/10036; G06T 2207/10016; G06T 2207/30184

(57) ABSTRACT

The present invention provides methods, apparatus, and systems for analyzing a structure using thermal imaging. A plurality of images of a structure are automatically captured using one or more image capture devices. The images may be captured in one or more ranges of wavelengths of light. The images are then processed to generate image data for the images. The image data can then be analyzed to determine one or more properties of the structure. The images may be captured at an angle with respect to the structure of between approximately 45 to 135 degrees. The images may be captured during a time where one of indirect or no sunlight is present.

This application claims the benefit of U.S. provisional patent application No. 62/173,038 filed on Jun. 9, 2015 and is a continuation-in-part of commonly-owned U.S. patent application Ser. No. 14/734,336 filed on Jun. 9, 2015, which is a continuation of International patent application no. PCT/US2013/031554 filed on Mar. 14, 2013, each of which is incorporated herein by reference in their entirety and for all purposes.

### BACKGROUND

The present invention relates to the field of thermal analysis of a structure. More specifically, the present invention is directed towards methods, apparatus, and systems for analyzing a structure and determining properties of the structure using thermal imaging.

As awareness of building energy waste increases and its environmental consequences become increasingly impactful, it may be desirable to survey large physical territories for buildings that are poorly insulated or otherwise using energy inefficiently using vehicle-based thermal imaging technology.

Methods for surveying thermal losses from buildings are available. For instance, a thermal image of an area or a specific building or object may be obtained using a handheld thermal imaging device. The resultant image may be inspected visually for signs of excessive heat loss. If the image is obtained for an area, the image may be compared with a map of the area to identify the building or other object from which the heat loss originates. Images obtained via handheld imaging devices are costly to obtain at large scale and require substantial manual effort and human labor, thereby limiting the scope of building energy audits and improvements that reduce overall energy consumption at large scales.

While there are systems and methods presently available for surveying buildings, there are various limitations associated with such methods. For example, a thermal image alone may not provide information that is sufficient to accurately determine one or more properties of a structure, such as a commercial or residential building. Handheld approaches for acquiring thermal images may not allow for a rigorous analysis that is necessary for determining the energy losses specifically due to conductive or convective leaks as opposed to radiative heat loss from heat trapped by the building from the sun.

Therefore, it would be advantageous to more reliably, scalably and cost effectively identify structural parameters, such as, for example, energy efficiency of a structure, which may be dependent at least in part on thermal insulation characteristics of the structure, as well as to provide an associated analysis of the heating and cooling systems of the structure that depend on a combination of the thermal analysis and other data.

The methods, apparatus, and systems of the present invention provide the foregoing and other advantages.

### SUMMARY OF INVENTION

The present invention provides methods, apparatus, and systems for analyzing the structural and energy properties of structures, such as homes, apartment complexes, office buildings, warehouses, hospitals, military bases, schools and similar campuses, and the like, without the need for substantial human intervention. However, the present invention is not limited to the analysis of building structures, but is also applicable to individual building components and other objects, such as vehicles, machinery, street lights, power lines, telephone poles, electric transformers and other electric grid infrastructure, gas pipelines and other inanimate objects having a thermal signature.

In one example embodiment of the present invention, a method for analyzing a structure is provided. A plurality of images of a structure are automatically captured. The images may be captured in one or more ranges of wavelengths of light. The images are then processed to generate image data for the images. The image data can then be analyzed to determine one or more properties of the structure. The images may be captured at an angle with respect to the structure of between approximately 45 to 135 degrees. The images may be captured during a time where one of indirect or no sunlight is present.

The processing and analyzing of the images may be carried out by a software program developed in accordance with the present invention running on a computer processor (also referred to herein as a CPU). It should be understood that the present invention may be implemented in a combination of computer hardware and software in communication with the image capture device(s), as discussed in detail below.

The software may be adapted to automatically determine and account for the angle of the images and to normalize the image data to account for solar radiation when generating the image data to provide accurate energy usage information and loss estimates.

The images may be captured using at least one image capture device mounted on a vehicle. The images may be captured autonomously while the vehicle is in motion.

The images may captured at a distance of between approximately 5 to 50 meters from the structure. The software may be adapted to automatically determine and account for the distance when generating the image data.

The images may be captured using one or more different image capture devices from one or more different angles or distances.

The one or more properties of the structure may comprise at least one of a presence of the structure, a size of the structure, a shape of the structure or a portion of the structure, energy information of the structure, heating information of the structure, thermal energy leaks of the structure, structural, heating, and energy consumption information, energy flux per leak, a conductive, convective, and/or radiant heat flow of the structure or an area of the structure, an energy consumption rate of the structure, and the like.

The structural, heating, and energy consumption information may include one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof degradation, a presence of water damage, structural degradation, thermal emissivity, a presence or fitness of windows, a presence or fitness of roofing material, a presence or fitness of cladding, R-value, wetness, and the like.

The image data may be combined with a separate set of data to form a corresponding combined data set. The analyzing may be carried out on the combined data set. The separate set of data may comprise one or more of public geographic information service (GIS) data, private GIS data, demographic data, self-reported homeowner information, manual energy audit information, weather information, climate condition information, energy usage information, contractor information, structural material information, property ownership information, location information, time and date information, imaging capture device information, global positioning system data, light detection and ranging (LIDAR) data, odometry data, vehicle speed data, orientation information, tax data, map data, utility data, humidity data, temperature data, and the like.

Two or more of the images may be stitched together to form multi-channel images.

The one or more ranges of wavelengths of light may comprise at least a first and a second range of wavelengths of light. At least a first set of the images may be captured in the first range of wavelengths of light and a second set of the images may be captured in the second range of wavelengths of light. For example, one set of images of a structure may be captured in a first range of wavelengths (for example, 350 nm to 1.2 μm). A second set of images of the structure may be simultaneously captured in a second range of wavelengths. A third set of images may be captured using another spectrum of light and/or a LIDAR device. A single vehicle mounted capture device may capture images in both the wavelength ranges, or multiple image capture devices may be used.

The first and second sets of images may be captured at different points in time.

The method may further comprise calibrating one or more image capture devices used to capture the images. The calibrating may comprise providing a calibration target with an asymmetrical circle pattern adapted for use in simultaneously determining parameters that describe distortion in thermal and near-infrared image capture devices, and comparing patterns from the calibration target and patterns extracted from sample images to obtain calibration coefficients for each of the one or more image capture devices and to obtain registration coefficients between each of the one or more image capture devices. The calibration target may be subject to evaporative cooling to provide a temperature differential visible by the image capture devices.

The method may also comprise detecting at least one structural feature or component of the structure, and performing at least one of conductive, convective, and radiant heat flow analysis of the at least one structural feature or component. The at least one structural feature or component may comprise at least one of windows, doors, attics, soffits, surface materials, garages, chimneys, foundations, or the like.

In addition, the method may further comprise providing one or more reports comprising information pertaining to at least one of: energy consumption information for the structure; water damage; energy leaks; heat loss; air gaps; roof degradation; heating efficiency; cooling efficiency; structural defects; energy loss attributed to windows, doors, roof, foundation and walls; noise pollution; reduction of adulterants; reduction of energy usage and costs; costs of ownership; comparisons with neighboring or similar structures; comparison with prior analysis of the structure; safety; recommendations for repairs, remedial measures, and improvements to the structure; projected savings associated with the repairs, remedial measures, and improvements to the structure; offers, advertisements and incentives for making the repairs, remedial measures and improvements to the structure; insurability; risk; and the like.

In one example embodiment, the images may be captured using at least one image capture device mounted on a vehicle. The images may be captured while the vehicle is in motion. The software may be adapted to automatically account for a change in orientation of the vehicle or of the corresponding image capture device when generating the image data.

A system for analyzing a structure is also provided in accordance with the present invention. In one example embodiment of a system, one or more image capture devices are provided for automatically capturing a plurality of images of a structure. The images may be captured in one or more ranges of wavelengths of light. A computer processor is also provided, which is programmed for: processing the images to generate image data for the images; and analyzing the image data to determine one or more properties of the structure. The images may be captured at an angle with respect to the structure of between approximately 45 to 135 degrees. The images may be captured during a time where one of indirect or no sunlight is present.

In some examples, a set of images of the structure may be captured with a vehicle mounted image capture device over a range of wavelengths including visible, near infrared (NIR), mid-wavelength infrared (MWIR) and long wavelength infrared (LWIR). Orientation and structural information can be captured using ranging laser imaging detection and ranging (LIDAR) or radio detection and ranging (RADAR) sub-systems of the image capture device.

The system may also include additional features as discussed above in connection with the various embodiments of the corresponding method. The present invention also encompasses the apparatus which make up the system and which are required for carrying out the method.

The present invention may employ a manned or unmanned vehicle having one or more mounted image capture devices, which can be driven through a street, road or other pathway containing or adjacent to the structure to be analyzed. The images can be taken and analyzed in a high-throughput manner, such that many buildings can be analyzed in a short time period by a computer processor running a computer program or multiple, related computer programs developed in accordance with the present invention. Images of the structure may be taken in various ranges along the electromagnetic spectrum, including but not limited to the far-infrared band, mid-infrared band, the near-infrared band, and the visible-light band without the need for a human to be physically present to manually operate a thermal camera at a specified distance and angle from the building. These images can be automatically analyzed to find the relevant objects in the scene, including buildings and various building components such as windows, doors, exterior surface materials, soffits, foundations, chimneys and obstructions to the building such as trees, shrubs, cars and other items that may obstruct the line of sight.

Once the relevant objects in the scene are identified, the software can determine one or more structural and energy properties of the structure, including but not limited to energy consumption, energy leakage, the quality of insulation, structural integrity, structural degradation, and the like. Such analysis may be performed using the image data alone or by combining the image data with data from various sources, such as public and private geographic information services (GIS) and demographic data, weather data, self-reported information from the owner of the building, manual energy audit information, and the like. The software may then infer the structural integrity and energy efficiency of the building and its various components (such as windows, doors, attics, foundations, siding, chimneys, and the like) without the need for a human to view and subjectively analyze the thermal image.

With the structural and energy properties of the structure determined, the software can automatically generate recommendations and associate financial costs for remedying various building issues using a database of climate, weather, fuel, material and other costs and assumptions specific to the region scanned. These recommendations and associated costs can then be provided to the owner in a variety of different end products automatically generated by the computer software.

The provided high-throughput data gathering and analysis provided herein can also facilitate more accurate and faster estimates of the energy consumption and total cost of ownership of various structures, including insurance costs, property values, property tax, and mortgage rates, together with potential reduction in costs associated with building improvements.

### BRIEF DESCRIPTION OF THE DRAWINGS

The present invention will hereinafter be described in conjunction with the appended drawing figures, wherein like reference numerals denote like elements, and:

FIG. 1A schematically illustrates an example embodiment of a method for analyzing a structure, in accordance with the present invention;

FIG. 1B schematically illustrates another example embodiment of a method for analyzing a structure, in accordance with the present invention;

FIG. 1C schematically illustrates an example embodiment of image processing steps in accordance with the present invention;

FIG. 2A schematically illustrates an example embodiment of an image capture device, in accordance with the present invention;

FIG. 2B schematically illustrates a further example embodiment of an image capture device, in accordance with the present invention;

FIG. 3A schematically illustrates, in a top plan view, an example embodiment of a system for acquiring data to analyze a structure, in accordance with the present invention;

FIG. 3B schematically illustrates, in an elevational view, the example system shown in FIG. 3A;

FIG. 4 schematically illustrates an example embodiment of a system for facilitating methods of the disclosure, in accordance with the present invention;

FIG. 5 shows an example embodiment of a screenshot of an application (top portion), which displays homes adjacent to one another, and thermal images (bottom portion) associated with a home selected from the application;

FIG. 6 shows an example embodiment of a screenshot of an application (top portion), which displays homes adjacent to one another, and thermal images (bottom portion) associated with a home selected from the application;

FIGS. 7-16 show example embodiments of reports that can be generated by a system programmed to obtain sets of images of a structure and to analyze the sets of images;

FIG. 17 is an example embodiment of a plot that shows a correlation between building model score and natural gas consumption score;

FIG. 18 shows an example embodiment of a workflow for processing data; and

FIG. 19 shows an example embodiment of a calibration target with an asymmetrical circle pattern for camera calibration in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The term “vehicle,” as used herein, refers to any type of vehicle, including but not limited to a car, truck, train, bus, motorcycle, scooter, boat, ship, robot, or the like. A vehicle can be a manned vehicle. As an alternative, a vehicle can be an unmanned (or autonomous) vehicle, such as a drone or an autonomous/self-driving automobile. A vehicle can travel along a dirt road, gravel road, asphalt road, paved road, or other type of road or terrain. As an alternative, a vehicle can travel along a waterway, such as a river or canal or fly through the air.

The term “structure,” as used herein, generally refers to any commercial or residential structure. Examples of structures include homes, apartment complexes, office buildings, warehouses, hospitals, military bases, schools and similar campuses, and the like. The term structure also encompasses individual building components or elements of a structure (e.g., a roof, façade, windows, doors, attic, soffits, surface materials, garages, chimneys, foundations and the like) and other objects, such as vehicles, machinery, street lights, power lines, telephone poles, electric transformers and other electric grid infrastructure, gas pipelines and other inanimate objects having a thermal signature.

The term “geolocation” (also “geo-location”), as used herein, generally refers to the real-world geographic location of an object. In some cases, geolocation can refer to the virtual geographic location of an object, such as in a virtual environment (e.g., virtual social network). A geolocation can be a geographical (also “geographic” herein) location of an object identified by any method for determining or approximating the location of the object. In some example embodiments, the geolocation of a structure can be determined or approximated using the geolocation of an object associated with the user in proximity to the structure, such as a mobile device in proximity to the user. The geolocation of an object can be determined using node (e.g., wireless node, WiFi node, cellular tower node) triangulation. For example, the geolocation of a user can be determined by assessing the proximity of the user to a WiFi hotspot or one or more wireless routers. As another example, the geolocation of an object can be determined using a global positioning system (“GPS”), such as a GPS subsystem (or module) associated with a mobile device, and/or a combination of any of GPS, GNSS, LIDAR, and IMU technology, as well as vehicle odometry. The geolocation system of the present invention also includes software for refining the GPS positioning and orientation of a structure, enabling position and location determination within an accuracy of +/−10 centimeters.

The present invention provides methods, apparatus, and systems for acquiring images or sets of images from a structure and analyzing the images to determine properties of the structure. The invention can be implemented with the aid of a computer system having one or more computer processors programmed to carry out various aspects of the present invention, as discussed in detail below.

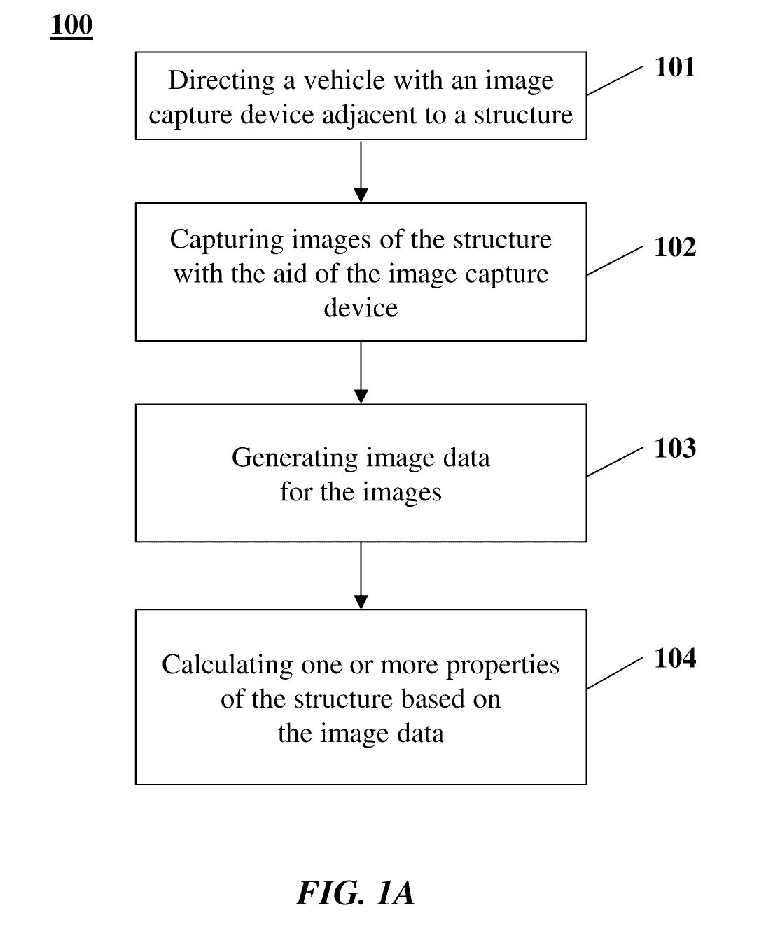

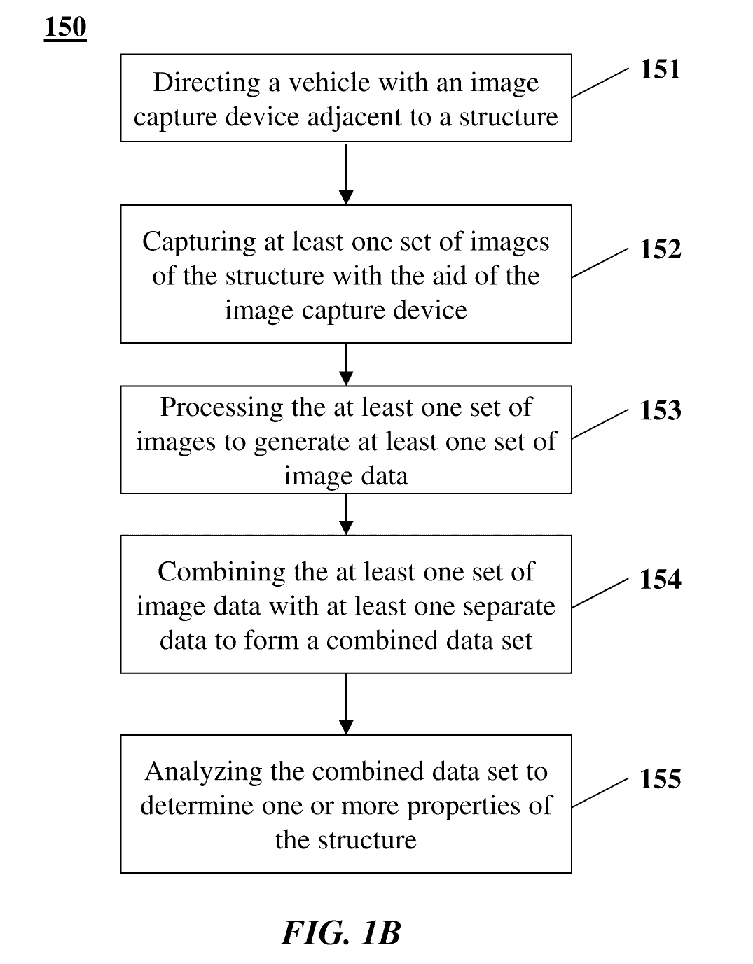

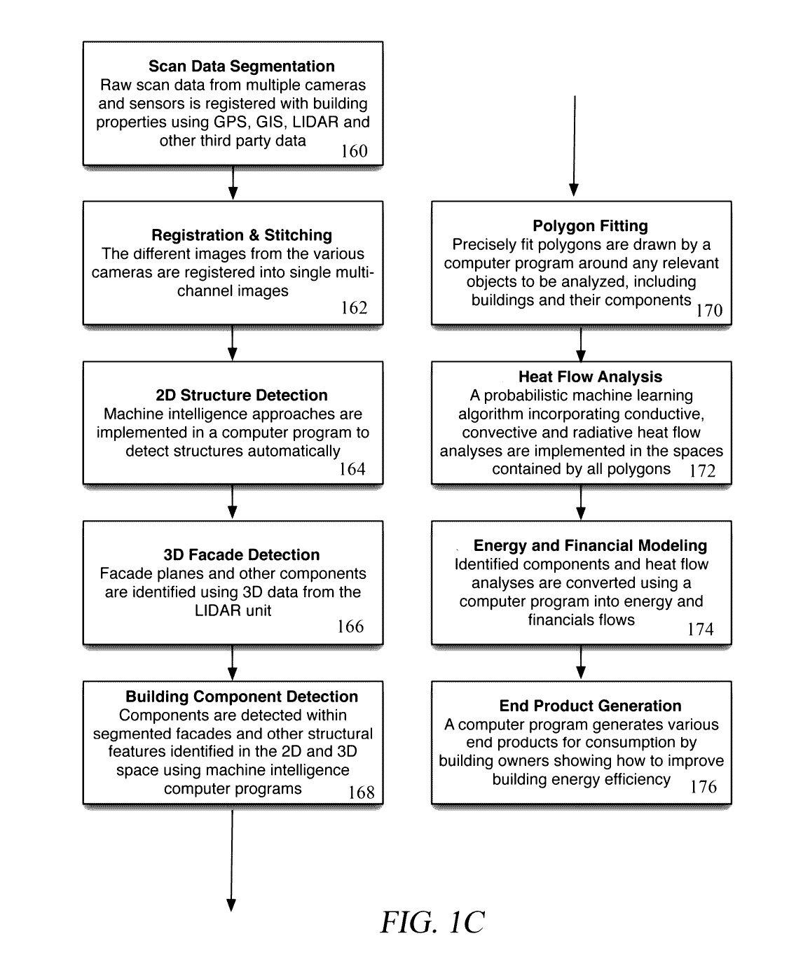

FIG. 1A schematically illustrates an example embodiment of a method 100 for analyzing a structure in accordance with the present invention. In a first operation 101, a vehicle with an image capture device (or multiple image capture devices) is directed adjacent to a structure, such as, for example, a building. Next, in a second operation 102, images of the structure are autonomously captured with the aid of the image capture device. The images may be captured while the vehicle is in motion. Additional sets of images may be captured as well. The image capture devices operate automatically to capture the images without user interaction (other than initial initiation of the operation of the system). The images may be captured simultaneously or substantially simultaneously as the vehicle passes by the structure, or at different times. Next, in a third operation 103, the images are processed to generate image data for the images. In a fourth operation 104, one or more properties of the structure may then be calculated or determined based on the image data.

The one or more properties of the structure may comprise a presence of the structure, a size of the structure, a shape of the structure or a portion of the structure, energy information of the structure, heating information of the structure, thermal energy leaks of the structure, structural, heating, and energy consumption information, energy flux per leak, a conductive, convective, and/or radiant heat flow of the structure or an area of the structure, an energy consumption rate of the structure, or the like. The structural, heating, and energy consumption information includes one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof degradation, a presence of water damage, structural degradation, thermal emissivity, a presence or fitness of windows, a presence or fitness of roofing material, a presence or fitness of cladding, R-value, wetness, or the like.

The image data may be combined with a separate set of data to form a corresponding combined data set. The combined data set is analyzed to determine the one or more properties of the structure. The separate set of data may comprise one or more of public geographic information service (GIS) data, private GIS data, demographic data, self-reported homeowner information, manual energy audit information, weather information, climate condition information, energy usage information, fuel usage information, contractor information, structural material information, property ownership information, location information (such as GPS data or the like), time and date information, imaging capture device information, global positioning system data, orientation data, light detection and ranging (LIDAR) data, odometry data, vehicle speed data, orientation information, tax data, map data, utility data, humidity data, temperature data, or the like. In addition, the separate data may be obtained from smart home systems or appliances, Internet connected thermostats (such as, for example, a Nest thermostat or the like), and other network connected home energy monitoring devices.

As discussed above, the one or more properties of the structure may also comprise energy flux per leak. In addition to determining energy flux per leak based on actual energy leaks shown in the images and optionally the separate data sets mentioned herein, the energy flux per leak for portions of the structures not shown in the images can be extrapolated based on the actual energy flux per leaks obtained from the images and inferred structural, heating, and energy consumption information computed for unseen portions of the structure (e.g., portions of the structure hidden behind other objects in the image such as trees or shrubs, or portions of the structure not shown in the available images, such as additional sides of the structure not visible from the image capture location). The energy flux per leak can be used to determine a total energy flux of the structure.

The one or more properties of the structure may also comprise an energy consumption profile of the structure or a rate of use of energy for the structure. The images can be used to determine the rate at which energy is being used by the structure or dissipated from the structure. For example, the images can be used, together with weather data (e.g., heating and cooling degree days) to determine the energy consumption of the structure and associated energy costs of the structure.

In some cases, the energy consumption rate for a specific structure may be compared with a second energy consumption rate of the same structure or of another structure (e.g., a neighboring structure, another similar structure). The second energy consumption rate can be determined as set forth above or elsewhere herein, or obtained from an energy audit or database containing information of or related to the second energy consumption rate.

FIG. 1B schematically illustrates a further example embodiment of a method 150 for analyzing a structure in accordance with the present invention. In a first operation 151, a vehicle with an image capture device is directed adjacent to the structure. In a second operation 152, at least one set of images is automatically captured of the structure with the aid of the image capture device as the vehicle passes by the structure. Each of the at least one set of images can be in one or more ranges of wavelengths of light. For example, at least a first set of images of the structure can be captured in a first range of wavelengths of light and a second set of images of the structure can be captured in a second range of wavelengths of light. The images may be captured simultaneously or at different times. Next, in a third operation 153, the at least one set of images is processed to generate one set of image data for each corresponding set of images. The at least one set of images can be processed using a computer processor running software in accordance with the present invention. In a fourth operation 154, the at least one set of image data is combined with separate data (e.g., GPS data, LIDAR data, GIS data, private GIS data, weather data, demographic data, self-reported homeowner information, manual energy audit information, etc. as discussed above in connection with FIG. 1A) to form a combined data set. Next, in a fifth operation 155, the combined data set is analyzed to determine one or more properties of the structure (as discussed above in connection with FIG. 1A). The combined data set can be analyzed by computing a correlation between one or more individual images of the combined data and the separate data, and analyzing the at least one set of image data based on the correlation.

FIG. 1C illustrates an example embodiment of image processing in accordance with the present invention. In a first processing step 160, image data from the images obtained from the image capture device (e.g., in the form of raw scan data from multiple cameras and sensors) are mapped onto geospatial and property ownership data to identify the precise location and ownership of structures scanned. GPS, GIS, LIDAR and other third party data may be used in this process.

In a next processing step 162, the different images from the various cameras are registered and stitched into single multi-channel images. For stitching the various camera images together, a homography is generated by matching like features that overlap across different images of the structure that are taken from different orientations or fields of view (e.g., such as upper and lower images of a structure, images taken at different vertical or horizontal angles with respect to the structure, and the like), and/or that are taken at different wavelengths. Then, using the homography, one image (e.g., a top image) is transformed and overlapped onto another image (e.g., a bottom image), or vice versa. For registration across multiple wavelengths, features are matched across the near infrared and long wave infrared wavelengths to generate a homography, and then the homography is applied to map the near infrared image onto the long wave infrared image space, or vice versa. The images are then layered into a single multi-channel and multi-spectral image combining the different camera fields of view and wavelengths.

In a further processing step 164, machine intelligence approaches are implemented (e.g., such as neural networks and classifiers) to automatically detect structures in the stitched and registered images.

In a next processing step 166, 3D point cloud data (e.g., from a LIDAR unit) is applied to the output of the machine intelligence that discovered the structures to detect with high precision the specific facades, planes, and other components of the structures.

In an additional processing step 168, similar machine intelligence algorithms are used to detect within segmented facades and planes other structural features such as windows, doors, attics, soffits, surface materials, garages, chimneys, foundations, and other components and features of buildings (or other structures being analyzed).

In a further processing step 170, closed geometric shapes are tightly fitted around the detected features and components of buildings using machine intelligence, temperature and 3D point cloud data. The closed geometric shapes may be one or more of a polygon, a circle, an oval, an irregular closed shape, or the like. Different shapes may be used around different features and components.

In an additional processing step 172, a probabilistic machine learning algorithm is used to perform conductive, convective and radiative heat flow analyses on the surface area of features and components within the geometric shapes fitted in step 170.

In a next processing step 174, the output heat flow analyses is used to determine energy and financial flows and models for each of the features and components, in part through connection with a preprocessed database(s) of information related to weather and climate conditions and energy, contractor, material and other prices.

In a final processing step 176, end products and interfaces are automatically generated (e.g., such as direct mail, email, websites and other marketing and informational products) that display thermal images and analysis resulting from the foregoing processing steps.

Using the geometric shapes, the software of the present invention may also calculate the percentile distribution of energy loss or energy leaks associated with all or each of the identified building shapes or structures of a given type and material (e.g. brick walls, siding, windows, doors, attics, soffits, roofing, joints, foundations, chimneys, and the like) scanned with a given orientation in a geographic region (e.g., a street, neighborhood, city block, city, military base, school campus, or the like), correcting for observation time (to account for residual solar heat) via a linear regression of time and emissivity. These percentile values are then matched to an assumed prior gaussian r-value distribution for the region in question. The software is thus able to perform a robust relative analysis of scanned structures in any given area to identify particular high or low performing structures in terms of energy loss or energy leaks. For instance, this software could automatically identify the 10% (or any arbitrary percentage) worst performing buildings, windows, doors, walls, roofing, soffits, joints, attics, foundations, chimneys, and other structures and components in a given area, such as a neighborhood, city, county or state.

Methods of the present disclosure can help identify, calculate, quantify and also improve homeowner comfort and building energy efficiency. In some examples, captured images can be augmented and analyzed with additional data to produce a custom, confidential report that identifies ways to improve comfort, lower interior noise pollution, reduce the ability of adulterants (e.g., allergens, mold, pollens and so on) to enter the home, and reduce energy bills. The report can be provided to a user on a user interface of an electronic device of the user, such as a web-based user interface or a graphical user interface or in other marketing channels like direct mail and email. The report can include one or more offers and/or advertisements with incentives (e.g., product or service discounts) to enable the user to take advantage of offers that may be available to enable the user to make improvements to the structure.

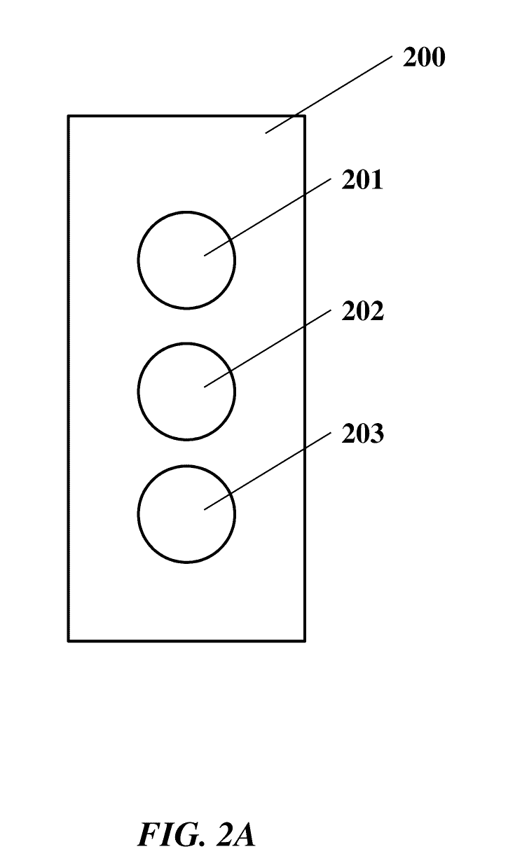

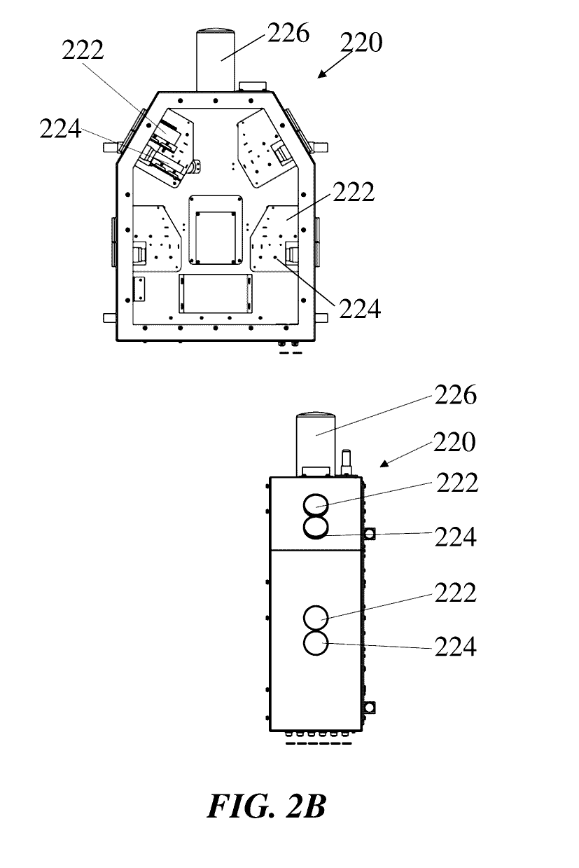

FIG. 2A shows an example embodiment of an image capture device 200. The device 200 may comprise a first sensor or image capture element 201 for taking images (or sets of images) at a first wavelength or range of wavelengths, a second sensor or image capture element 202 for taking images (or sets of images) at a second wavelength or range of wavelengths, and a third sensor or image capture element 203 for taking images (or sets of images) at a third wavelength or range of wavelengths. The image capture device 200 can comprise more or fewer sensors or image capture elements. Additional images or sets of images can be captured using additional image capture elements. Alternatively, separate image capture devices may be used, each with different image capture elements or sensors.

The sensors 201, 202, 203 may be individually tuned to respective wavelengths of light. The sensors may be tuned to, for example, the infrared (IR) portion of the electromagnetic spectrum, the ultraviolet portion of the electromagnetic spectrum, or the visible portion of the electromagnetic spectrum. As an alternative, or in addition, the image capture device 200 can be configured for light detection and ranging laser imaging detection and ranging (LIDAR), radio detection and ranging (RADAR), detecting x-rays, and/or detecting electrons.

The image capture device 200 can capture or detect multiple images or sets of images of a structure on a large scale (e.g., 1-1000 sets). Each set of images can include one or more images. Each set of images of the structure may be taken at substantially the same time. In some cases, a set of images includes images (e.g., still pictures) of a structure at various points in time as the vehicle passes in front of the structure.

A set of images can be collected at a given wavelength of light or within a given range of wavelengths, with each set of images being collected at a different range of wavelengths. In some examples, the first range of wavelengths can be in a range from 350 nm to 1.2 μm. The second range of wavelengths can be in a range from 8 μm to 12 μm. In further examples, the first range of wavelengths may be within the visible and near infrared portion of the electromagnetic spectrum and the second range of wavelengths may be within the far or long-wave infrared portion of the electromagnetic spectrum.

Using an image capture device 200, a set of images of the structure can be captured in less than 3 seconds. The time period may vary based on various parameters of the image capture device 200 (e.g., shutter speed, exposure time), and the velocity of the vehicle. Data can be captured at a rate of between about 10-30 Hz. Vehicle speeds of less than 15 miles per hour are currently required for best results based on current image capture technology. As technology improves, higher vehicle speeds and image capture rates can be achieved. As an example, with the present invention, driving by a structure for about 3 seconds will typically yield greater than 90 images from one image capture device in one range of wavelengths.

FIG. 2B shows a further example embodiment of an image capture device 220 in accordance with the present invention. The image capture device 220 may include two long-wave infrared sensors 222 arranged on each side of the device 220, as well as two near infrared sensors 224 arranged on each side of the device 220. The image capture device 220 shown in FIG. 2B may also include a LIDAR system 226. The image capture device 220 may be mounted on the roof of a vehicle. Providing sensors on both sides of the device enables the device to capture images from separate structures simultaneously (for example, images of structures across the street from each other).

FIG. 2B shows the LIDAR system 226 incorporated into the image capture device 220. However, the LIDAR system may also be provided in a separate housing and mounted to the vehicle separately from the image capture device. For example, the image capture device 200 of FIG. 2A may be used with an independent LIDAR system mounted to the vehicle in different locations.

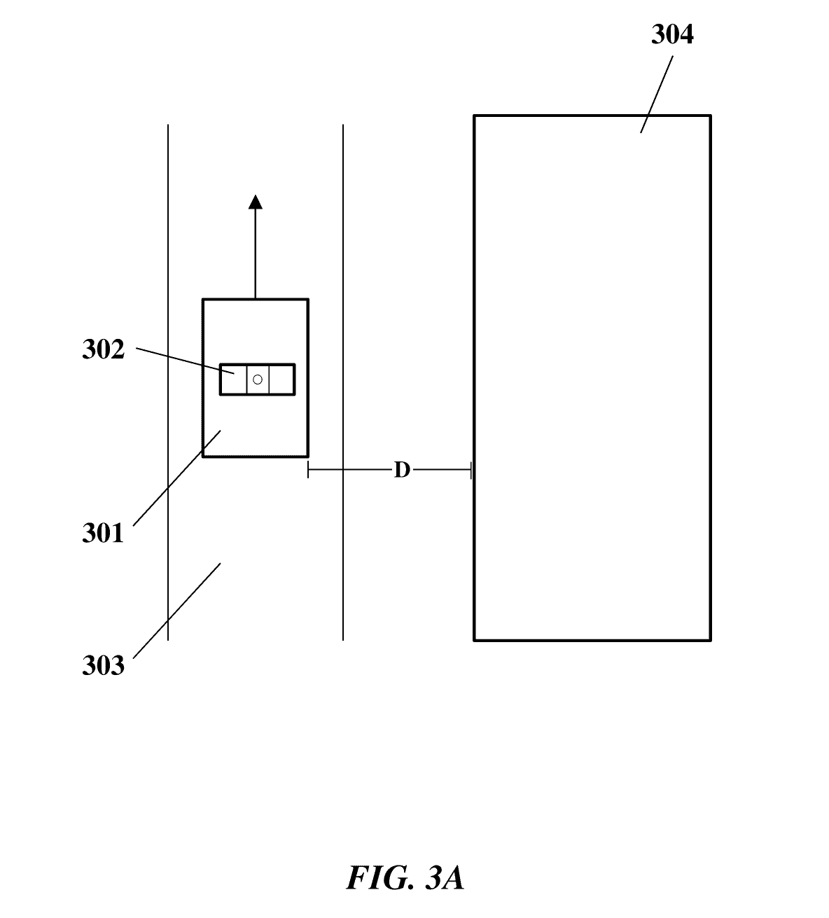

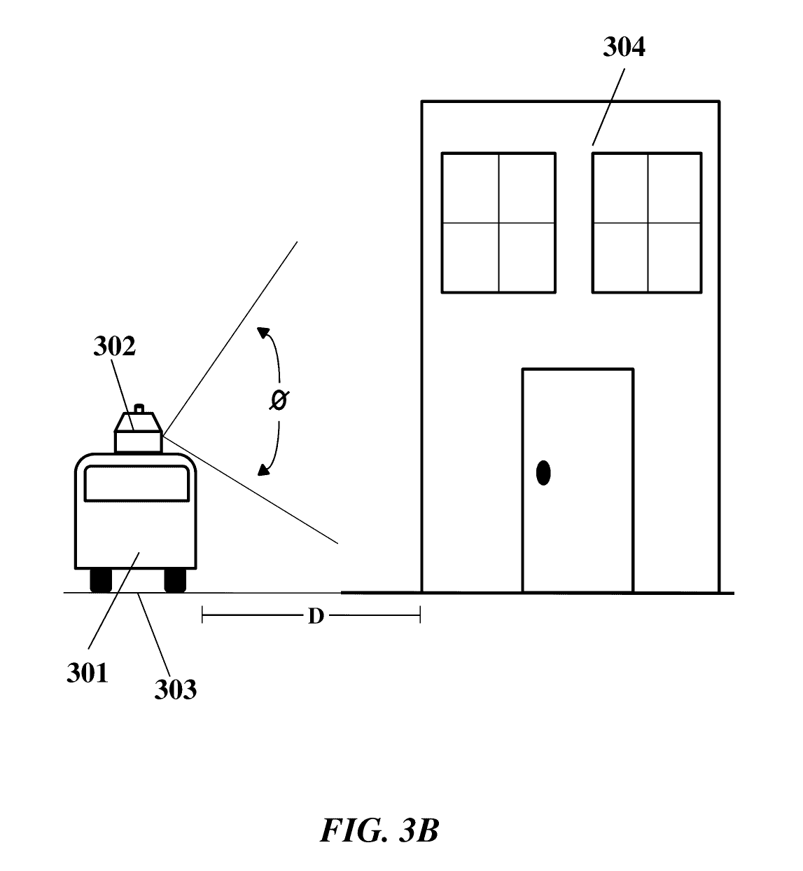

FIG. 3A schematically illustrates an example embodiment of a system and method for analyzing a structure shown in a top plan view. FIG. 3B shows a rear elevational view of example embodiment of FIG. 3A. A vehicle 301 carrying an image capture device 302 (e.g., the device 200 of FIG. 2A or 220 of FIG. 2B) is moving along a road 303 adjacent to a building 304. The vehicle 301 is moving along the road in the direction of the arrow in FIG. 3A. As the vehicle 301 moves along the road 303, the image capture device 302 captures one or more sets of images of the building 304. The images can be subsequently processed with the aid of computer software to provide data for analyzing the building 304 (as discussed elsewhere herein). The image capture device 302 may be arranged on a roof top of the vehicle 301 as shown in FIGS. 3A and 3B, or may be arranged on the trunk of the vehicle 301 or other suitable location. Associated devices, such as GPS, GNSS, LIDAR, RADAR and similar systems may be located at various points of the vehicle 301, including but not limited to the front, rear, trunk or roof of the vehicle 301.

The present invention also enables a configuration of the thermal imaging system such that it is not required that the image be taken with a clear line of sight to the structure or perpendicular to the structure (or other relevant object to be analyzed). Rather, the images may be captured at an angle with respect to the structure, for example, within a range of angles θ of about 45 to 135 degrees in a vertical image plane (as shown in FIG. 3B) and distances D of about 5 to 50 meters. As the image capture device 302 captures images while traveling past the building, various images from different angles in a horizontal image plane will also be captured. It is not necessary to know these angles or distances of image capture in advance as they are determined by the computer software in combination with advanced geolocation and orientation capabilities built into the vehicle-based imaging system. The computer software of the present invention can then account for such angles and distances when generating the image data to provide an accurate determination of the properties of the structure, such as those related to energy usage information and loss estimates.

The present invention also enables the imaging system to scan anytime in which direct light from the sun is not present and still deliver an accurate analysis of the energy efficiency and loss profile of any structures. This is possible due to computer software that takes into account and normalizes for solar radiation. The computer software may also specifically incorporate convective, conductive and radiative heat flow models using a machine learning algorithm that generates probabilistic outputs that automatically incorporate not just energy but also financial costs of ownership, as discussed in detail below.

As discussed above, the images may be captured while the vehicle 301 is moving along a surface 303 such as road, a parking lot, the ground, or the like. The surface 303 may be an uneven surface with changes in orientation, elevation, and direction. The image capture device 302 can be fixedly mounted on the vehicle 301. As the field of view of the image capture is sufficiently large, during processing the computer software can be configured to automatically account for any change in orientation of the vehicle 301 or of the image capture device 302 (either vertically or horizontally) with respect to a normal surface (such as that of a level ground surface perpendicular to the structure 304) when generating the image data (provided the structure or portion of the structure of interest remains in the field of view of the image capture device after such a change in orientation). For example, the computer software may be adapted to process the image (e.g., crop, resize, or re-orientate the image using image warping techniques, image blending techniques, and/or multi-pane imaging techniques) to adjust a plane of image capture to account for any change in orientation of the vehicle 301 and to place the structure 304 or portion of the structure of interest in the center of the image. Such a change in orientation can also be compensated for when stitching multiple images together which are taken at different orientations to the structure. For example, if the vehicle 301 has tilted 5° towards the west, then the system can compensate for the tilt when processing the image. In one example embodiment, the tilt of the image capture system 302 can be corrected algorithmically via a computer system programmed to correct the tilt. The tilt can be measured with the aid of a gyroscope or other system, such as a LIDAR system, onboard the vehicle 301. For example, use of a LIDAR system affixed to the vehicle 301 provides information regarding the orientation and direction of the vehicle 301, which can then be used to correct or compensate for discrepancies between images in a set of images that may be taken from different vehicle orientations during the travel of the vehicle 301 past the structure 304.

Alternatively, the image capture device 302 may be mounted so as to automatically adjust its orientation (e.g., tilt) to account for any change in orientation of the vehicle 301.

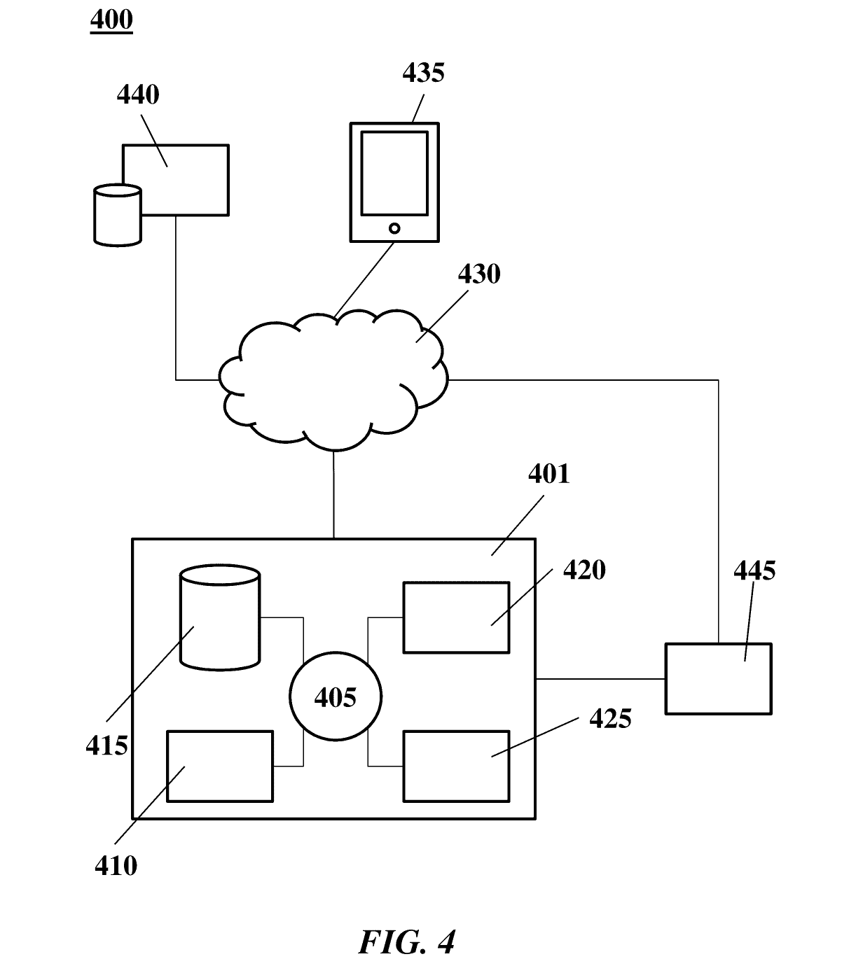

FIG. 4 shows an example embodiment of a system 400 programmed or otherwise configured to analyze a structure. The system 400 includes a computer server (“server”) 401 that is programmed to implement the methods disclosed herein. The server 401 includes a central processing unit 405 (CPU, also referred to as “processor” and “computer processor” herein), which can be a single core or multi core processor, or a plurality of processors for parallel processing. The processing unit 405 is adapted to run one or more computer programs developed in accordance with the present invention for carrying out the functions described herein. The server 401 also includes memory 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or other data repository) for storing data. The server 401 can be operatively coupled to a computer network (“network”) 430 with the aid of the communication interface 420. The network 430 can be the Internet, an intranet and/or extranet, or an intranet and/or extranet that is in communication with the Internet, a WAN, a LAN, a cellular network or other public or private network. The network 430 can include one or more computer servers, which can enable distributed computing, such as cloud computing. The network 430, in some cases with the aid of the server 401, can implement a peer-to-peer network, which may enable devices coupled to the server 401 to behave as a client or a server.

The storage unit 415 can store image data (e.g., sets of one or more images of an imaged structure) and one or more properties of a structure, together with associated data such as location, time of imaging, date of imaging, image capture device identification information, vehicle data such as speed, orientation, and location, weather information at time of imaging, and the like. The storage unit 415 can also store data relating to a structure or an area comprising structures, such as energy usage data, maps (e.g., aerial map, street map), tax data and utility data. The server 401 in some cases can include one or more additional data storage units that are external to the server 401, such as located on a remote server that is in communication with the server 401 through an intranet or the Internet.

The server 401 can communicate with one or more remote computer systems through the network 430. In the illustrated example shown in FIG. 4, the server 401 is in communication with a first computer system 435 and a second computer system 440 that are located remotely with respect to the server 401. The first computer system 435 and the second computer system 440 can be computer systems of a first user and second user, respectively, each of which may wish to view one or more properties of a structure. For example, the first computer system 435 and second computer system 440 can be personal computers (e.g., portable PC), slate or tablet PC's, cellular telephones, smartphones, personal digital assistants, smart watch, or other Internet enabled devices.

The system 400 may comprise a single server 401 or multiple servers in communication with one another through an intranet and/or the Internet.

The server 401 can be adapted to store structure (e.g., building) profile information, such as, for example, one or more properties of a structure (e.g., building), such as structural, heating, and energy information (e.g., energy consumption information), and other data, such as public geographic information service (GIS) data, private GIS data, weather data, demographic data, self-reported homeowner information, and on-site energy audit information. The structural, heating, and energy information can include one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof corrosion, a presence of water damage, structural degradation, thermal emissivity, a presence or fitness of windows, a presence or fitness of roofing material, a presence or fitness of cladding (e.g., siding, brick), R-value, and wetness. The server 401 can store other properties of the structure, such as energy flux per leak.

The example methods described herein can be implemented by way of machine (e.g., computer processor) executable code (e.g., software) stored on an electronic storage location of the server 401, such as, for example, on the memory 410 or electronic storage unit 415. During use, the software code can be executed by the processor 405. In some cases, the software code can be retrieved from the storage unit 415 and stored on the memory 410 for ready access by the processor 405. In some situations, the electronic storage unit 415 can be precluded, and the software code may be stored on memory 410. Alternatively, the software code can be executed on the second computer system 440.

The server 401 can be coupled to an image capture device 445 arranged on a vehicle. The image capture device may be as described herein, such as, for example, the image capture device 200 of FIG. 2A or 220 of FIG. 2B. The image capture device 445 can be configured to capture images or sets of images of structures at various wavelengths or ranges of wavelengths of light as discussed above. In an example, the server 401 may be in communication with the image capture device 445 by direct attachment, such as through a wired attachment or wireless attachment. As another example, the server 401 may be in communication with the image capture device 445 through the network 430. For example, the vehicle mounted image capture device 445 can comprise a communications interface for transmitting the captured images to the computer processor 405 for determining the one or more properties of the structure.

Thus, it should be appreciated that although FIG. 4 shows the computer processor 405 located remotely with respect to the vehicle mounted image capture device 445, the present invention includes embodiments where the computer processor 405 is hardwired to the image capture device and either integrated therewith or located in the same vehicle.

Information, such as one or more properties of a structure, can be presented to a user (e.g., buyer or seller) on a user interface (UI) of an electronic device of the user. Examples of UIs include, without limitation, a graphical user interface (GUI) and a web-based user interface. A GUI can enable a user to view one or more properties of a structure with graphical features that aid in visually identifying at least a subset of the one or more properties of the structure. The UI (e.g., GUI) can be provided on a display of an electronic device of the user. The display can be a capacitive or resistive touch display, or a head-mountable or eyeglass display.

Methods of the disclosure can be facilitated with the aid of applications (apps) that can be installed on electronic devices of a user. An app can include a GUI on a display of the electronic device of the user. The app can be programmed or otherwise configured to perform various functions of the system, such as, for example, displaying one or more properties of a structure to a user or reports related thereto.

The server 401 can be programmed or otherwise configured with machine learning algorithms, which may be used to automatically identify structural defects and structural inefficiencies, without human intervention. The server 401 may be adapted to automatically recognize structures without defects, and use those structures as baselines to identify structures with defects, without human intervention.

The image data can be used for estimating the total cost of ownership of a structure (e.g., residential building, commercial building, etc.).

In some examples, captured images of a structure are used to calculate a relative heat loss of the structure. For example, in each captured image, the background can be filtered to retain a portion of image that contains the structure. The average brightness (or intensity) of the image is then calculated, and the image can be digitized and processed to provide, for example, a temperature at various points within the image.

The image data can also be used to estimate one or more properties about the structure. In some cases, the material used to form the structure can be estimated by correlating a shape of the structure and loss information (e.g., as may be gleaned from analyzing the collected images) associated with the structure with that of known structures having known materials. For example, the system can determine whether the structure has a vapor barrier or determine the type of insulation of the structure. This can enable the system to recommend remedial measures to the user, such as the installation of a vapor barrier or a given type of insulation to decrease heat loss.

In some situations, the system can estimate physical, tangible qualities about the structure. Further, the system can estimate a fitness of items (e.g., whether a vapor barrier has been installed correctly, whether insulation has been installed correctly, etc.). Based on these features, the system can estimate an R-value of the total envelope of the structure (e.g., whether the structure is adequately insulated) and consumption and utility cost.

Accordingly, the method may further comprise suggesting one or more fixes, remedial measures or improvements to the structure based on the determined one or more properties.

For example, the system can suggest one or more proposed remedial actions aimed at reducing or eliminating one or more identified leaks or structural defects of the structure to, for example, decrease the rate of heat loss from the structure. Estimated costs for the proposed remedial actions, together with energy cost savings associated therewith and an estimated payback period for each remedial action may also be provided. For example, the system may identify an energy leak from a portion of the foundation and recommend the application of spray foam insulation at a cost of $X to achieve an annual savings of $Y in heating costs and $Z in electricity costs, resulting in the insulation costs being recouped in W years.

Upon determining a composition or makeup of the structure, the system can estimate a total cost of ownership of the structure. The total cost of ownership can be calculated from the value of the structure, the overall energy usage of the structure (e.g., within a given period of time), and in some cases other data, such as, for example, the cost of travelling to and from the structure. For example, it may be more expensive for a user to travel from a structure to a city if the structure is in a remote (or rural) location. Transportation cost can increase the total cost of ownership. In such a case, a rural structure may have a higher total cost of ownership than a structure located closer to the city. Reports regarding the cost of ownership, property structures, defects in property structures, energy usage, energy leakage, remediation options with associated costs and cost savings, and the like, can be provided to the structure owner.

The system can provide a user of the structure comparison information if a neighbor of the user or user located in a similar location has a comparable structure. For example, the system can provide the user with a total cost of ownership (TCO) for owning a home of the user, and provide the user a comparison of the user's TCO to the TCO of a neighbor of the user with a home similar to the user.

An estimate of TCO can be beneficial to various users. For example, a homeowner may want to know the TCO in order to make improvements to the home of the homeowner to decrease the TCO and, consequently, save money. TCO can also be useful for insurance, tax estimation, and mortgage estimation purposes.

Methods and systems of the present disclosure can provide for revenue protection and utility consumption verification. For instance, sets of images captured of a structure in addition to separate data that may be collected relating to the structure can be used to verify utility consumption associated with the structure. For instance, from images collected of a structure, in some cases in addition to separate data, the server 401 can determine a projected utility cost of the structure. The server 401 can then compare the projected utility cost to the actual utility cost. If there is a discrepancy, the server 401 can alert the user (e.g., homeowner, utility) of the discrepancy, and the user can subsequently take measures to rectify the discrepancy.

For example, a homeowner is paying $100/month for natural gas. From images collected of a home of the homeowner in addition to the hourly or daily temperature over the course of the year in the user's location, the server 401 determines that the average natural gas cost for the homeowner should be $75/month. The server 401 notifies the homeowner of the discrepancy via, for example, a user interface of an electronic device of the homeowner. The server 401 can also recommend that the homeowner take certain actions, including having the gas meter of the homeowner inspected to make sure it is functioning properly.

As another example, a homeowner is paying $20/month for natural gas. From images collected of a home of the homeowner in addition to the hourly or daily temperature over the course of the year in the user's location, the server 401 determines that the average natural gas cost for the homeowner should be $75/month. The server 401 determines that it is unlikely that the homeowner's utility cost on a monthly basis is reflective of the actual utility usage of the homeowner. The server 401 notifies the utility of the discrepancy, such as, for example, using a user interface of an electronic device of the utility. The server 401 can also recommend that the utility may want to have a gas meter of the homeowner inspected to make sure it is functioning properly.

Utility consumption verification may involve collecting and analyzing images from multiple structures in a given area and calculating an average utility cost in the area. For instance, from five homes imaged in a neighborhood, the server 401 can calculate an average utility consumption of the homes. The actual utility consumption of a given home among the five homes can be compared against the average, and the homeowner of the given home can be notified if the utility consumption of the homeowner is above the average (e.g., as this may indicate that the home of the homeowner is not as efficient as other homes among the five homes).

Methods of the present disclosure may be used to assess building safety. For instance, images captured of a building may be analyzed and compared to images from similar buildings to assist in determining (together with other information from other sources) whether the building is safe to occupy.

Methods of the present invention can be used to disaggregate structural and behavioral effects on utility bills from collected images, in some cases together with other data. Methods of the present invention enable a user (e.g., homeowner) to determine what fraction (or portion) of a utility bill of the user is due to structural parameters (e.g., defects in the structure, poor insulation, no vapor barrier) and what fraction of the utility bill of the user is due to the user's behavior (e.g., the user prefers to keep the structure warmer than other users in similar structures).

In some examples, using time varying imagery, images collected from the structure can be processed and compared to images collected from similar structures. The collected images can be correlated with additional data, such as GIS data, private GIS data, weather data, demographic data, self-reported homeowner information, and manual energy audit information. This can be used to estimate a living pattern of the user of the structure (e.g., homeowner), such as, for example, temperature preferences, heat and air conditioning usage, vacation patterns, and the like.

In some situations, the total consumption of energy in a structure (e.g., home) is a function of several factors, such as, for example, the baseline energy usage for keeping the structure at a given temperature (e.g., 25° C.) or within a given temperature range (e.g., 25° C. to 30° C.), and contribution from the user (e.g., the user's travel expenses in travelling to or from the home, the user's preferred temperature). The baseline energy usage can be a function of structural parameters of the structure (e.g., type and extent of insulation, structural materials, identified energy leakage, and the like).

In some situations, the system can generate a score and/or risk assessment for the user, which can be based on a separation (or disaggregation) of structural parameters from behavior. Behavior can include living behavior. The score can be provided on a user interface of an electronic device of the user, such as on a graphical user interface of the user. The system can generate a comfort score, total cost of ownership (TCO) score and/or efficiency score. As an alternative, or in addition to, the system can generate an insurability risk or mortgage risk.

In some examples, the user interface can also display a comparison of the user's score or risk to that of other users, such as the user's neighbor(s). The system can also present to the user a mean (or average) and/or median comfort score in an area (e.g., neighborhood, city) of the user. The system can provide a comparison of the user to similar homes, in some cases with similar demographics (e.g., family size), or a comparison of the user to homes with similar structure (e.g., 1920s farm homes) or square footage. The system can inform the user as to which portion of the score or risk of the user is due to structural parameters and which portion is due to the behavior of the user.

The following non-limiting examples are provided for illustration only and are not intended to limit the scope of coverage of any of the claims.

### Example 1

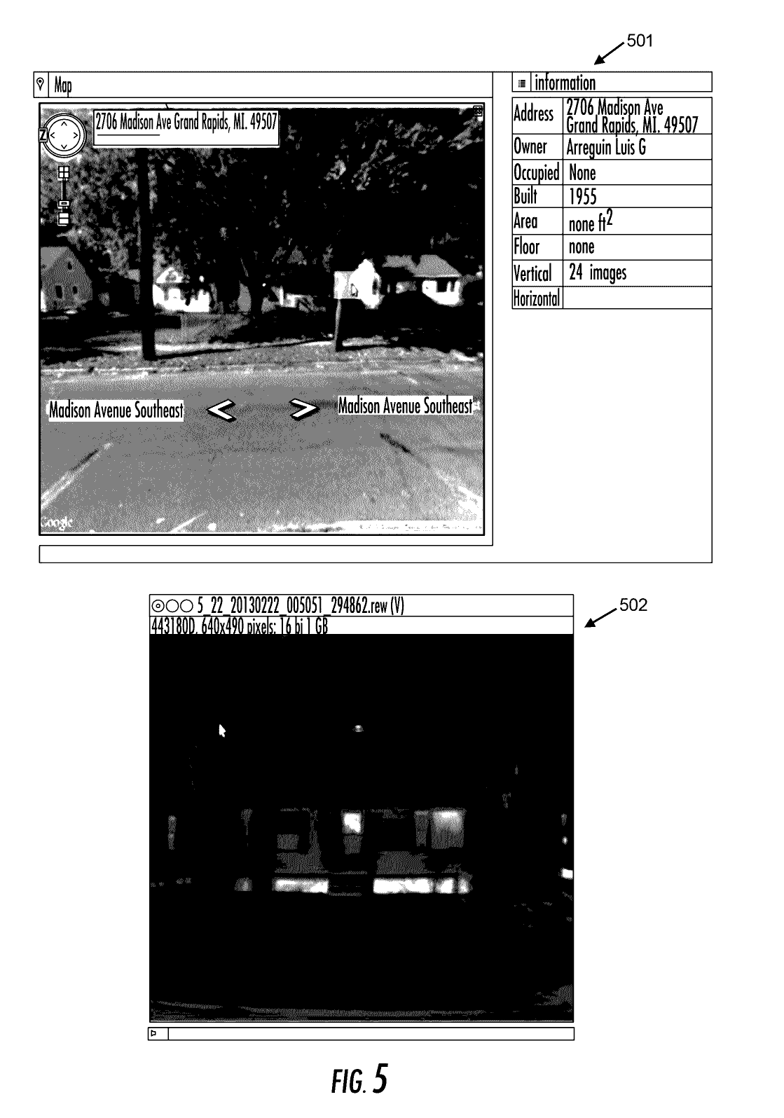

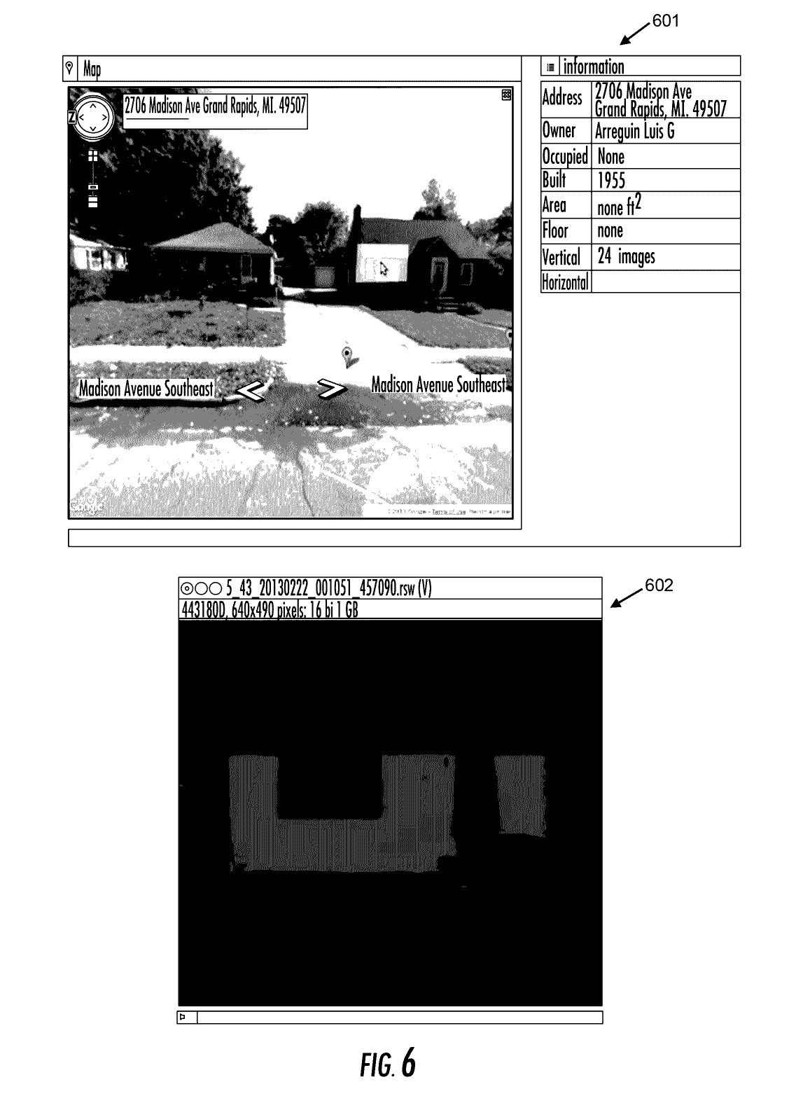

FIGS. 5 and 6 show example screenshots from a user application (app) provided in connection with an example embodiment of the present invention. The top portions 501 and 601 of FIGS. 5 and 6 displays homes adjacent to one another. A user of the app may select a home from the images shown at 501 and 601. Upon selection, the app displays a thermal image of the home to the user, shown at the bottom portions 502 and 602 of FIGS. 5 and 6. Each app provides an address of the building and indicates the number of vertical images associated with a given building (e.g., 24 images at 501 and 601 in the examples shown) which can be viewed via the app.

### Example 2

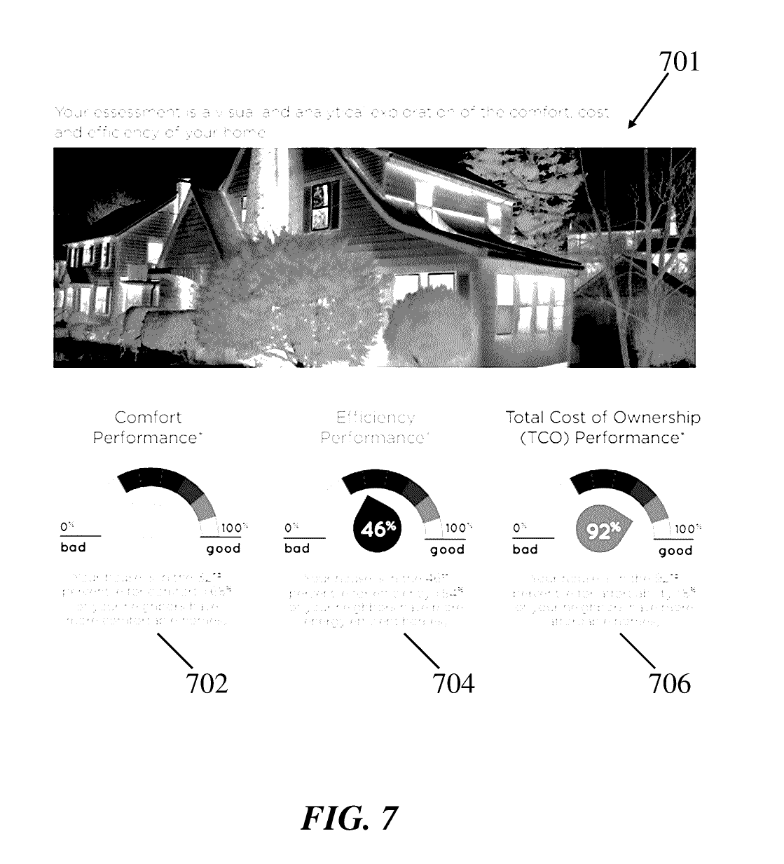

FIGS. 7-16 show example reports that can be generated by a system from the sets of images obtained of the structure and the subsequent analysis of the images. The reports can be generated for a user, such as an owner of the house or commercial building. The reports can be presented by way of an overall assessment of the structure.

FIG. 7 shows an example thermal image of a home 701 and various example metrics associated with the home. The metrics are derived by capturing images of the home and processing the images along with separate data, as described elsewhere herein. The metrics include comfort performance (or score) 702, efficiency performance 704, and total cost of ownership (TCO) performance 706, all of which are displayed as percentages or percentiles, with 0% being “bad” and 100% being “good.” The metrics can also include various risk scores, such as a score associated with an insurability risk or mortgage risk of the user. For the illustrated home, the comfort performance is 32%, efficiency performance is 46%, and TCO performance is 92%. The TCO performance indicates that the house is in the 92nd percentile for affordability. In other words, 8% of neighboring homes are more affordable homes in terms of TCO.

Those skilled in the art will readily appreciate that the metrics can be displayed any number of different ways, such as, for example using different charts or graphs, and/or associated scoring systems.

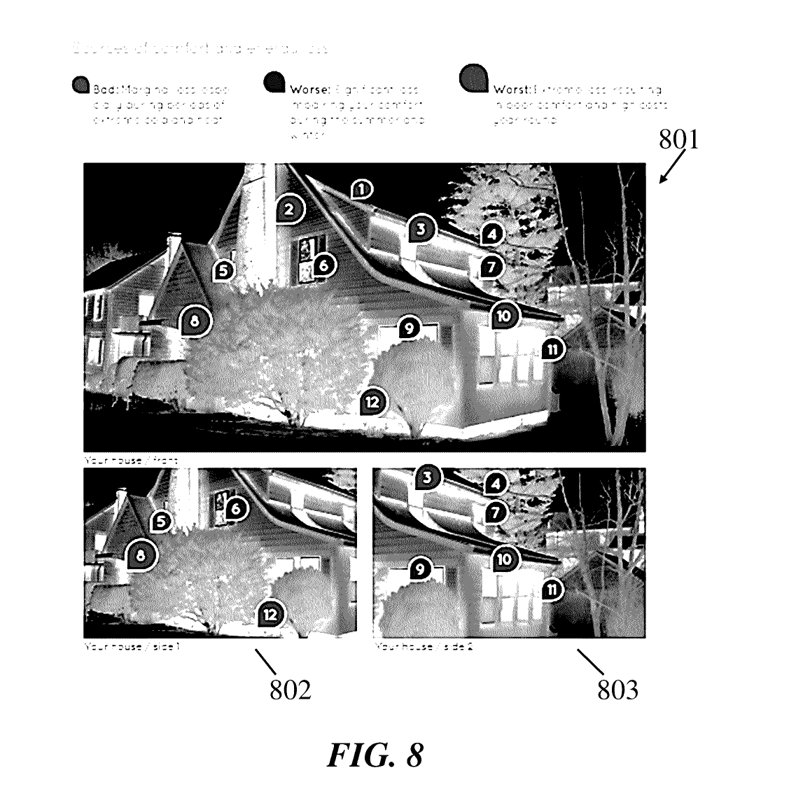

FIG. 8 shows an example thermal images 801, 802, and 803 of the house of FIG. 7 with an identification of losses (e.g., heat losses, energy leaks) at various locations of the house. Image 801 shows losses from an overview of one angle of the house. The images 802 and 803 show losses at a first side and second side of the house, respectively. Locations in which losses are categorized as the “worst” are displayed in red (larger) balloons; locations in which losses are categorized as “worse” than other locations are displayed in purple (medium sized) balloons, and locations in which losses are categorized as “bad” are displayed in blue (small) balloons. Losses that are categorized as “worst” may require immediate attention, as they are identified by the system as being “extreme losses.” Losses that are categorized as “worse” are significant losses, but not extreme losses—worse losses may be attended to after worst losses. Losses that are categorized as “bad” are marginal losses.

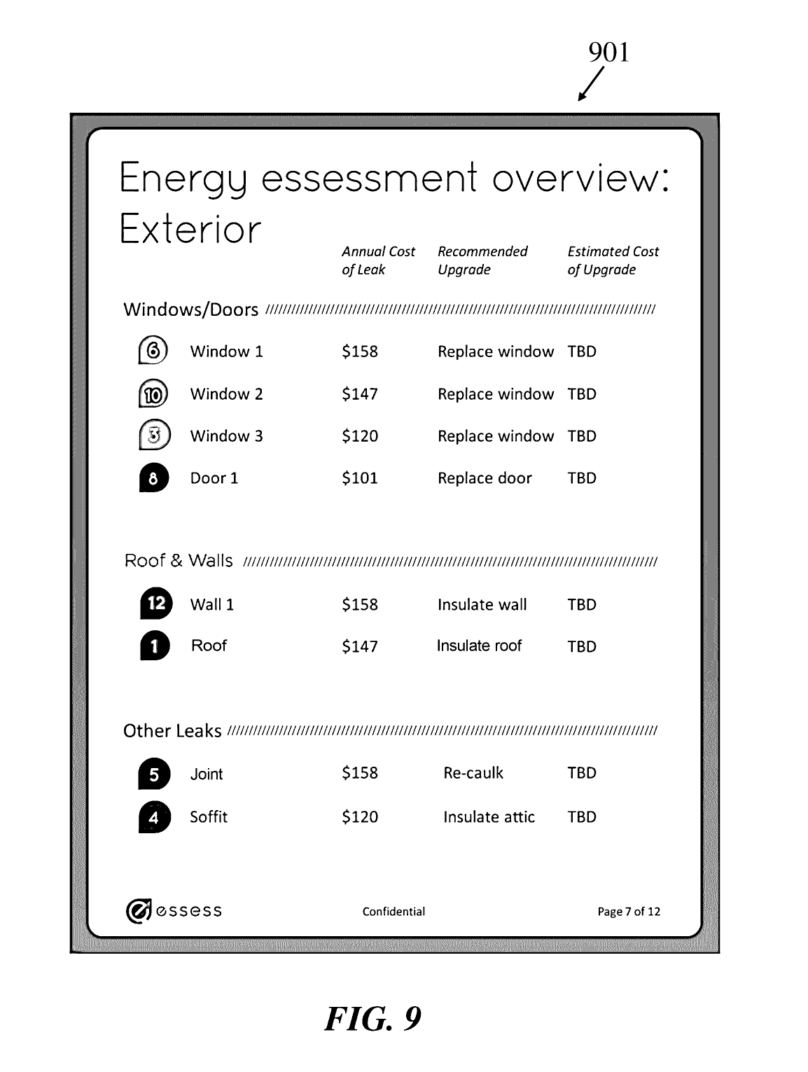

FIG. 9 is an example of a report 901 that is generated by the system to provide an energy assessment overview of the house of FIG. 7. For each loss identified in FIG. 8, the report 901 provides an estimated annual cost associated with the loss. The report also includes a recommended upgrade. For instance, the system recommends that the user replace the windows identified by balloons 6, 10, and 3 of FIG. 8. In some situations, the system can calculate an estimated cost for the upgrade and include that in the report. The report provides an assessment overview of the losses as identified in FIG. 8 associated with windows/doors (balloons 6, 10, 3, and 8), roof and walls (balloons 12 and 1), and other leaks (balloons 5 and 4).

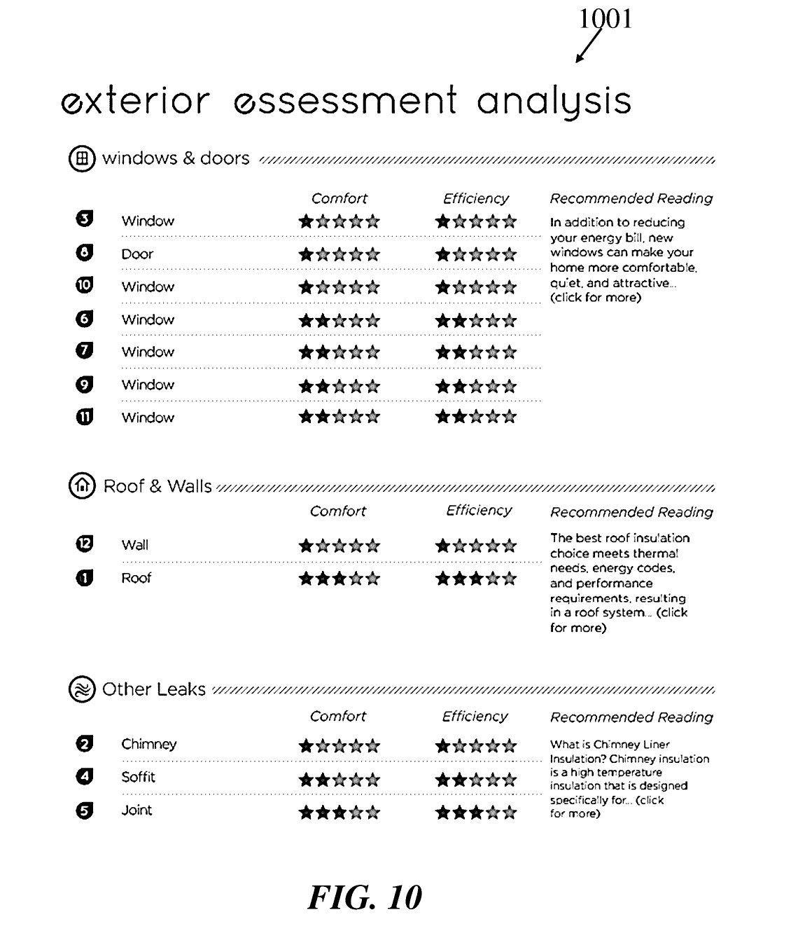

FIG. 10 shows an example of an exterior assessment analysis 1001 associated with the house of FIG. 7. For all losses identified in FIG. 8, the analysis 1001 provides a comfort score and an efficiency score, which are displayed by a star rating out of five stars, with one star being a poor rating and five stars being a great rating. The losses are categorized by “Windows & Doors” (top group), “Roof & Walls” (middle group), and “Other Leaks” (bottom group). The analysis also provides a recommended reading associated with each group of losses. For example, the loss associated with a window of the house (top row) has a one star rating under comfort and a one star rating under efficiency, which indicates that the window provides minimum comfort and is minimally efficient. Within each group, the losses are sorted by comfort and efficiency ratings, from worst rating to best rating.

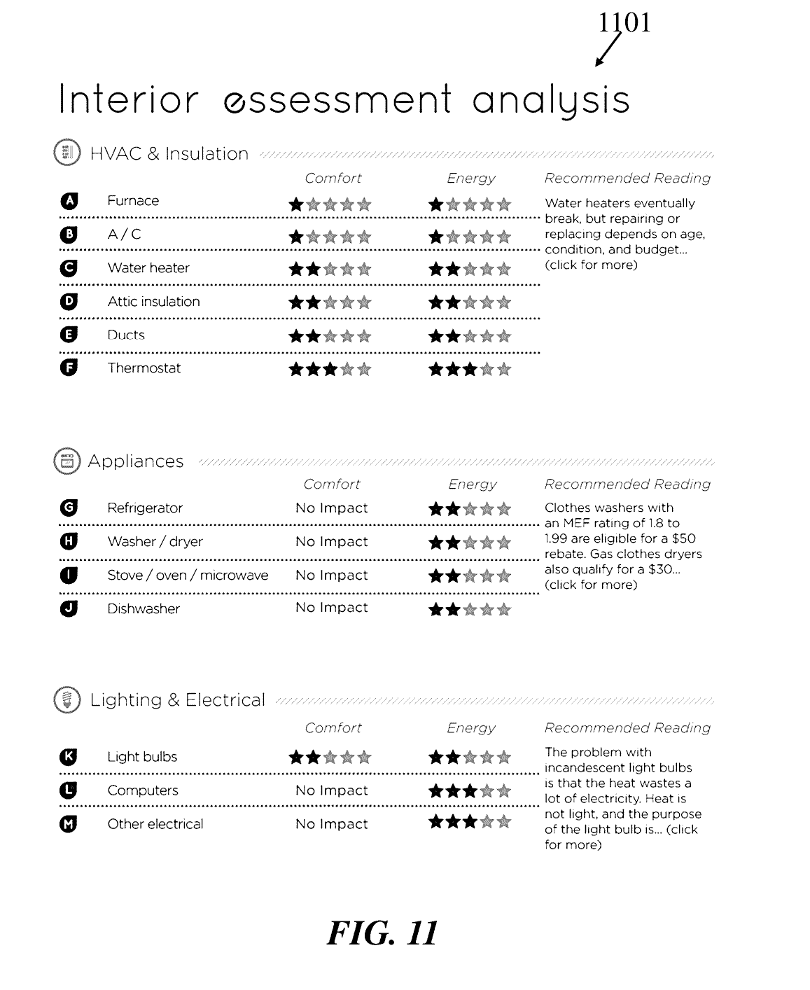

FIG. 11 shows an example of an interior assessment analysis 1101 associated with the house of FIG. 7. For interior features (i.e., furnace, A/C, water heater, attic insulation, ducts, thermostat, refrigerator, washer/dryer, stove/oven/microwave, dishwasher, light bulbs, computers, and other electrical), the analysis 1101 provides a comfort score and an energy efficiency score, which are displayed by a star rating. The interior assessment can be determined by the system from an assessment of energy losses and other structural defects, in addition to separate data, related to the house. The interior assessment includes three groups, namely “HVAC & Insulation” (top group), “Appliances” (middle group), and “Lighting & Electrical” (bottom group). The analysis also provides a recommended reading section with comments associated with each group. For example, the furnace (top row) has a one star rating under comfort and a one star rating under energy. Within each group, the features are sorted by comfort and energy ratings, from worst rating to best rating.

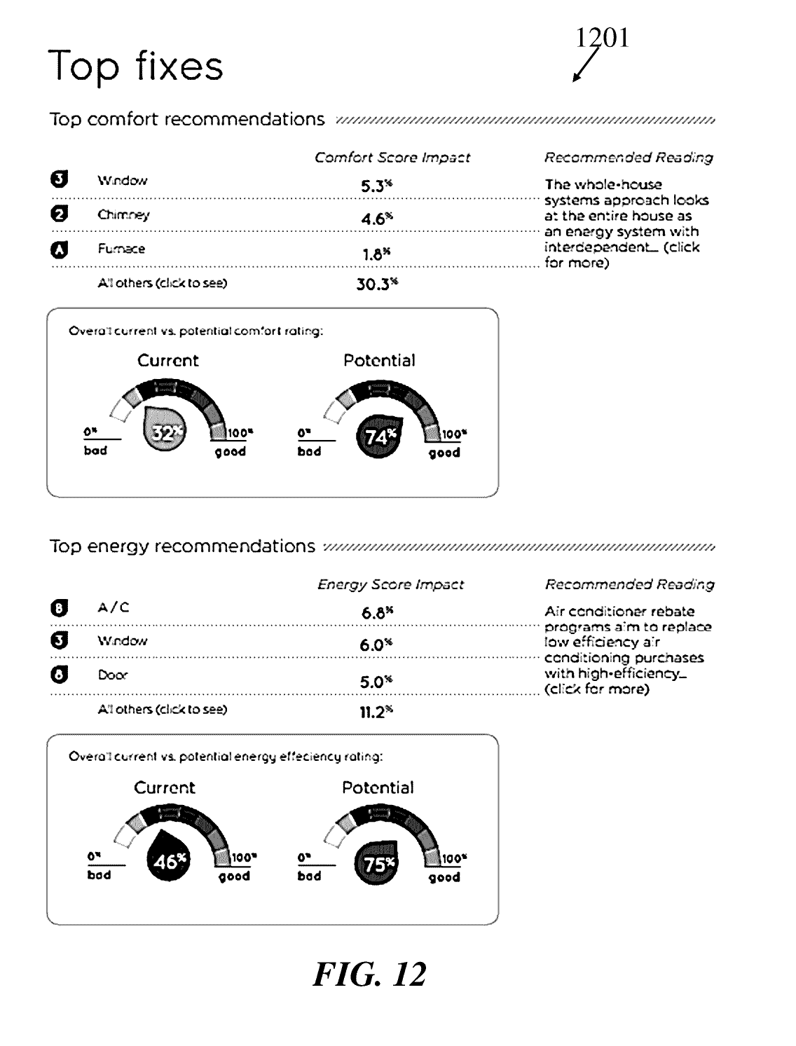

FIG. 12 is an example report 1201 that identifies top recommended fixes associated with the house of FIG. 7. The report 1201 provides the current comfort rating of the house (32%) and the potential comfort rating of the house (74%) if the recommended fixes are made. The report 1201 also provides the current energy efficiency rating of the house (46%) and the potential energy efficiency of the house (75%) if the recommended fixes are made. Under comfort rating (top block), the report 1201 identifies the top fixes that can be made (window, chimney and furnace), and the comfort score impact associated with each fix. Under energy efficiency (bottom block), the report 1201 identifies the top three fixes (A/C, window and door) that can be made to improve the energy efficiency of the house.

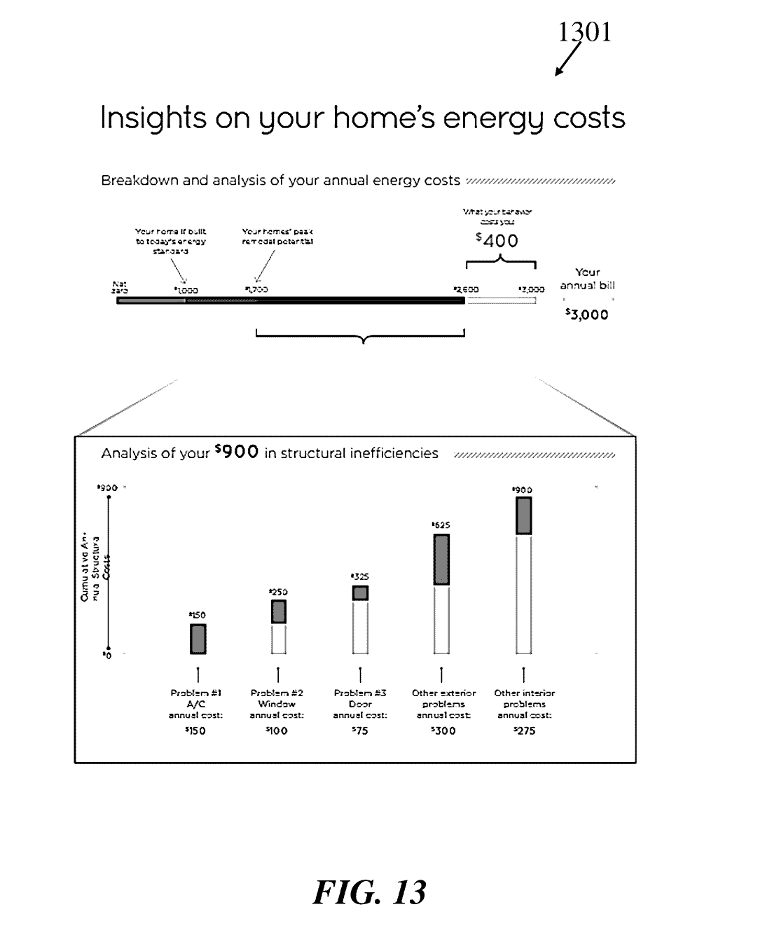

FIG. 13 is an example report 1301 that provides insight into the energy cost associated with the house. The report 1301 identifies an annual bill for the energy cost of the house ($3,000). The report 1301 indicates that $400 of the annual bill is associated with a behavior of the user and other occupants of the house. The report 1301 indicates that $900 of the annual bill is due to structural inefficiencies, and in the bar plot (bottom) provides a breakdown of the inefficiencies. The five columns in the bar plot are potential corrections that can be made, which in the example shown, may save the user $900 annually.

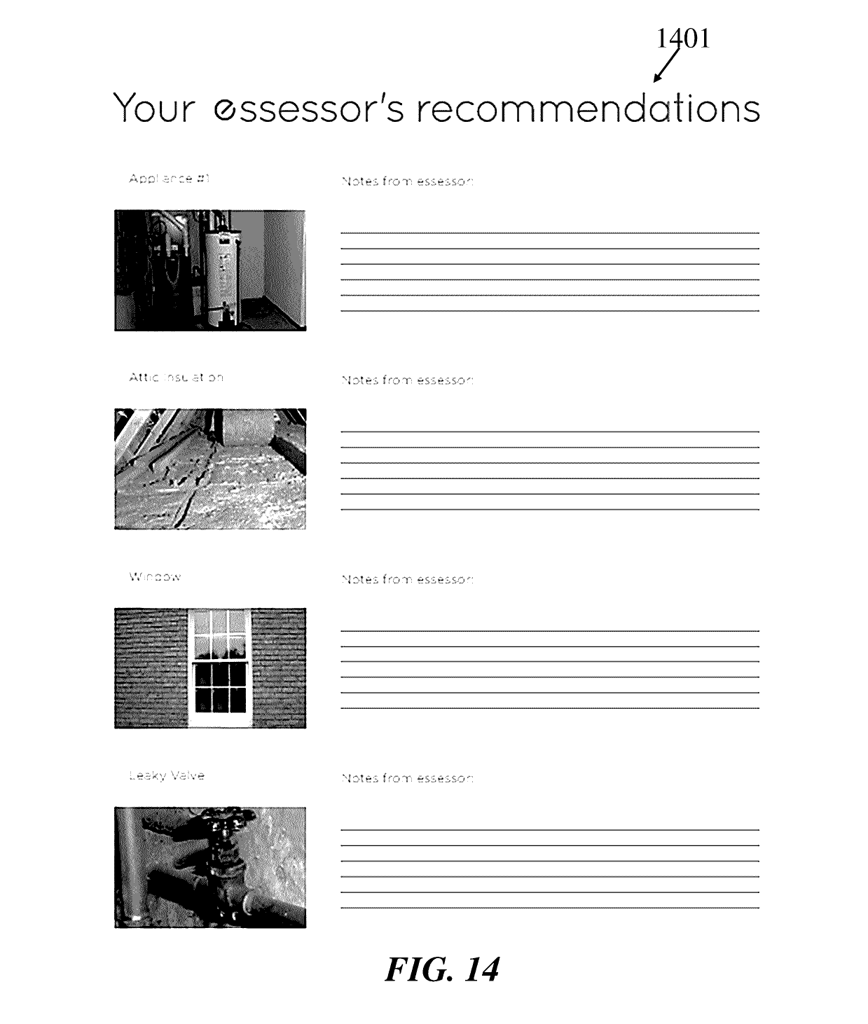

FIG. 14 shows an example report 1401 with recommendations for fixes that can be made to the house. The fixes include “Appliance #1,” “Attic Insulation,” “Window,” and “Leaky Valve.” The recommendations can include notes from an assessor who physically inspects the structure and the identified features or components identified in the report 1401.

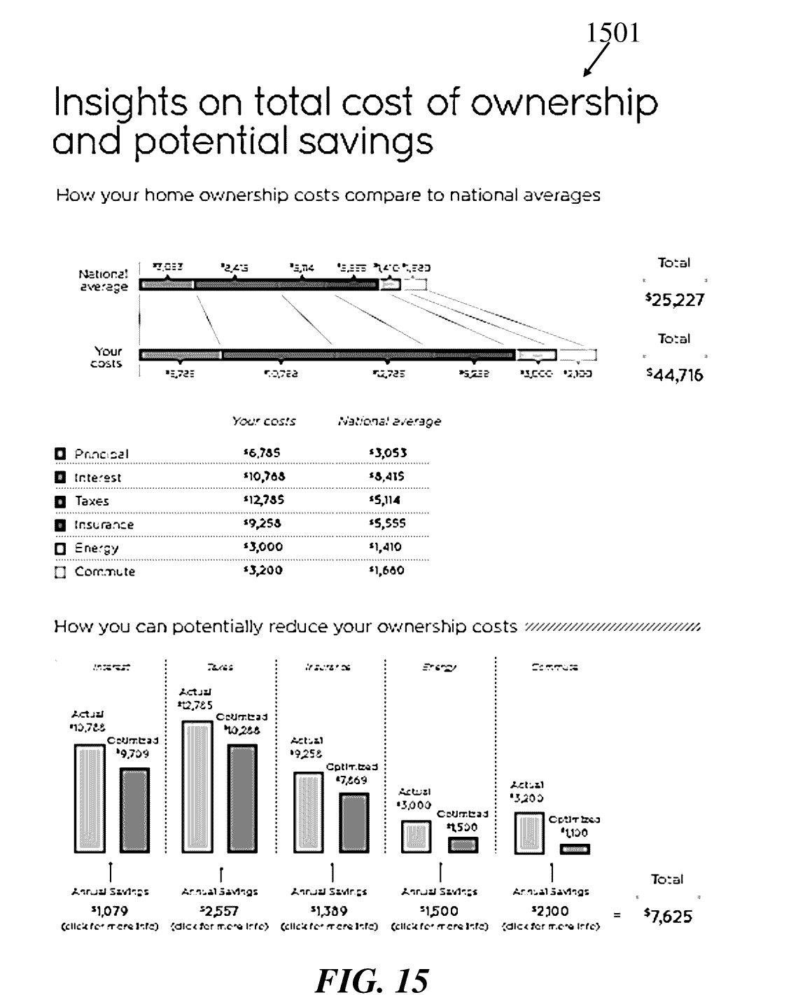

FIG. 15 is an example report 1501 with insights on the total cost of ownership (TCO) and potential savings. The TCO takes into account the principal cost (“Principal), associated interest (“Interest”) and taxes (“Taxes”), insurance costs (“Insurance”), energy costs (“Energy”) and cost of commute (“Commute”). The TCO of the user ($44,716) is displayed against a national average ($25,227). The national average can be generated by comparing the house of the user to similar homes, in some cases in similar areas. A bottom portion of the report 1501 shows examples of approaches that the user can take to potentially reduce the TCO of the user. The approaches include minimizing interest, taxes, insurance, energy and commute. The report 1501 indicates that the user can potentially reduce the TCO by $7,625 on an annual basis.

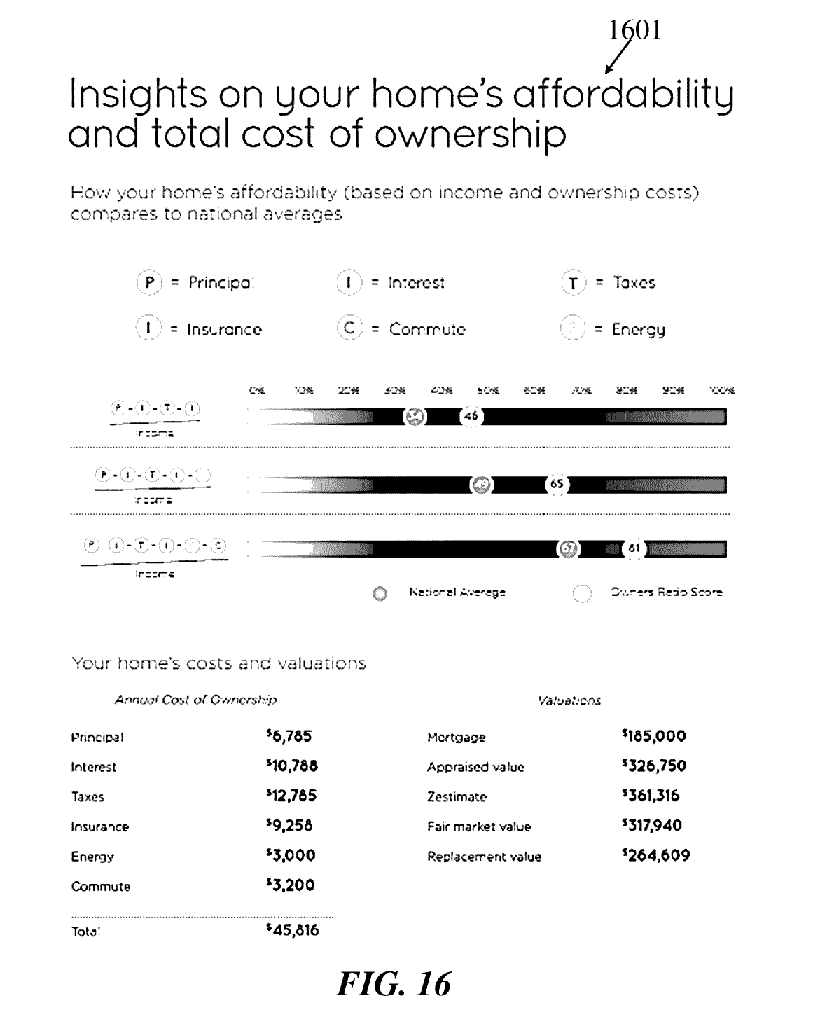

FIG. 16 is an example report 1601 with insights on the affordability and total cost of ownership of the house. The report 1601 provides an overview of how the affordability of the house of the user (based on income and ownership costs) compares to the national average.

### Example 3

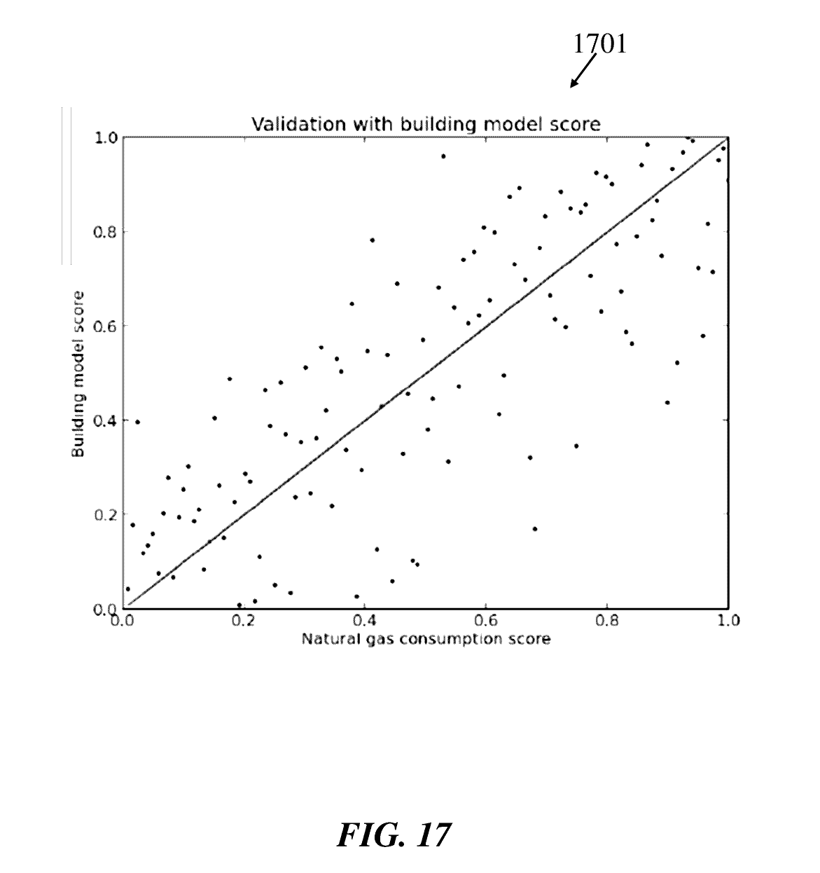

Structural data can be used to predict utility usage, which can be used to train systems for deriving utility usage from images collected of structures. For example, building data (e.g., living area) can be combined with a surface temperature of a house to draw a correlation between building data and surface temperature. FIG. 17 shows a graph 1701 of an example correlation between a building model score (y-axis) and natural gas consumption score (x-axis). The correlation of graph 1701 can be used to predict natural gas consumption for other buildings. For example, from sets of images collected of a building, a building score can be calculated that is a function of the size of the building and the temperature of the surface of the building. From the building score, graph 1701 can be used to estimate a natural gas consumption score of the building.

### Example 4

An analysis system can be used to interpret the thermal cameras' images and translate them into a library of quantified energy issues. This interpretation process has several steps. First, for image preprocessing, the system uses thermal camera calibration data to translate the raw infrared images into radiometric images. Other preprocessing steps include lens de-warping (i.e., removing the lens curvature effects from the image), synthetic aperture imaging (i.e., stitching together images from multiple cameras, while compensating for different camera poses/orientation, and making the resulting high-resolution panorama appear to have been captured from a single camera), automated contrast optimization (i.e., adjusting the image contrast to focus in on the temperature range of interest), and scene radiation correction (i.e., using three dimensional scene geometry and detected radiation sources to distinguish emitted vs. reflected radiation, which would cause an object to appear erroneously hot). Additional pre-processing and post-processing steps may be employed as well, such as registering the thermal images with visual and near-infrared synchronously captured images to support the identification of materials and specific components, as well as caching of all images to common formats (PNG, JPEG, TIFF) for use by analysis and developer applications.

After preprocessing, the system detects a building's energy issues through further image processing, computer vision, and machine learning. The system thresholds the temperature image by a minimum temperature to remove background detail and identify hotter regions of interest (ROIs) within the image. In each ROI, the system calculates multiple image features, such as corners, edges and thermal gradients, and texture patterns. These extracted image features form a rich description of the local information in each ROI. The system then feeds these features into a supervised learning algorithm, such as a support vector machine classifier, to predict the most likely energy leak class: window, air draft at a window edge, poorly insulated wall, insulation sag, door, attic gable, basement wall, etc.

Once each energy issue receives a class label, the system calculates the leak severity using a physics-based modeling approach. The system uses a probabilistic machine-learning algorithm to determine the temperature difference between the estimated indoor temperature and the recorded external air temperature. The temperature difference and the leak class' material properties allow the system to estimate the leak's R-value (i.e., the thermal resistance). With the R-values, the system constructs a heat-flow model (which may include conductive, convective, and radiative heat flow) to calculate the annual escaped energy through each leak, which is adjusted the by the local climate's heating degree days and cooling degree days. The heat flow model of a structure may be compared to other similar structures to obtain a relative analysis. The data about escaped energy (“negawatts”) are stored into the data library with each leak's other information.

With each energy leak quantified, the system performs both a micro-scale analysis per building and a macro-scale analysis per territory. For the micro-scale building analysis, the system ranks each leak by severity and calculates a raw energy score for the building. For the macro-scale analysis, the system translates buildings' raw energy scores into relative percentiles. The system also tallies the leaks by leak type across the territory, in order to compile a comprehensive energy report that describes and quantifies wasted energy across the territory.

### Example 5

This example provides a process flow for leak detection, characterization, classification and severity ranking. In such an example, the images can be pre-processed to generate a temperature image from the raw image. Next, the system generates a threshold of the image by temperature to isolate hotter regions in a scene of the image from cooler regions. The system then calculates image features (e.g., corners, edges, thermal gradients, texture patterns), and provides the image features into a classifier, such as a support vector machine (SVM) to predict the most likely leak class (e.g., window, wall, door, attic, basement, etc.).

For each leak, the system calculates a leak severity. The system can calculate the R-value based on the temperature difference and material properties, and calculate the annual heat flow of the leak based on heating and cooling degree days. The system then ranks the leaks according to their severities in wasted energy, and calculates an energy score of the structure.

Thus, the present invention can be used to analyze structural losses, such as, for example, structural characterization, quantification, and ranking of losses from a structure. For instance, gas energy losses can be ranked higher than vapor losses, and such ranking can be used to set the order in which the losses are addressed (e.g., energy losses are addressed first). Such methods can be used to identify leaks, such as fluid leaks, gas leaks, and energy leaks.

Methods provided herein can also be used for latent structural analysis, such as the analysis of structural degradation, roof corrosion, water damage, structural integrity. Methods provided herein may also be used for latent structural feature detection, such as, e.g., stud spacing, insulation (e.g., type, R-value, installation quality), presence of a vapor barrier, identification of heater type (e.g., central, baseboard, radiator), and the like.

### Example 6

One of the most difficult aspects of building energy analysis is disaggregating the total energy usage into the estimated behavioral component, such as thermostat settings, from the structural component, such as inadequate wall insulation. An energy analysis system of the present invention uses a probabilistic approach, which comprises calculating prior distributions on latent information (e.g., internal temperature) and subsequently, with a utility bill associated with the building, calculating the latent variables' most likely values.

The system creates a prior distribution of indoor air temperatures from previously reported thermostat settings for similar buildings. Building similarity is based on building type, architectural style, building age, building dimensions, occupancy level, and occupant demographics. HVAC system efficiency is similarly estimated from the above building characteristics, plus insulation properties and building envelope details that are visible from thermal imaging. The HVAC information can be modeled by extrapolating from neighboring and similar buildings that have HVAC information. The system combines these internal temperature and HVAC data with the building envelope information, as discussed elsewhere herein. The system calculates the maximum a posteriori estimate for the latent variables of indoor temperature and HVAC equipment using the relationship

θ_{MAP}(t,hvac)=arg max_{t,hvac}f(utility|t,hvac),

where ‘θ_{MAP}’ is the maximum a posteriori (MAP) estimate of the latent variables, ‘t’ is the indoor temperature, ‘hvac’ is the HVAC equipment and efficiency rating, “arg max” is the observed values of temperature (t) and HVAC equipment and efficiency rating (hvac), ‘utility’ is the recorded energy usage (e.g., utility bill), and f(utility|t, hvac) is the likelihood function for observing the energy usage given the indoor temperature and HVAC system. The system uses this statistical modeling to reverse engineer the most likely internal temperature setting and HVAC system. The MAP estimate allows the system to scale the magnitude of the wasted energy with the indoor temperature and HVAC system. With this information, the behavioral aspect (e.g., setting the thermostat) of energy consumption can be decoupled from the structural aspect (e.g., home insulation and energy efficiencies). The structural component is associated with the extra negawatts for the building envelope above the normal negawatts for an adequately weatherized building. The behavioral component is associated with the extra negawatts for temperatures more extreme than a standard thermostat setting, such as, for example, 65° F.

### Example 7

This example provides a process flow for disaggregating structure from behavioral components of structural energy use. In this example, the system analyzes the images and estimates the distribution of likely internal temperature and the efficiency of any heating, ventilation, and air conditioning (HVAC) system. The system can detect and quantify building envelope issues as described elsewhere herein (see, e.g., Example 5). With such distributions, the system can scale negawatt magnitude and calculate the posterior distribution of internal temperature. Next, given a utility bill associated with the structure, the system can reverse engineer the most likely internal temperature setting and subsequently use this estimate to split the total energy usage associated with the structure into the structural component and the behavioral component (e.g., thermostat settings). The structural component can be associated with the extra negawatts for the building envelope above the normal negawatts for a properly weatherized building. The behavioral component can be associated with the extra negawatts for temperatures more extreme than a standard thermostat setting (e.g., 65° F.).

### Example 8

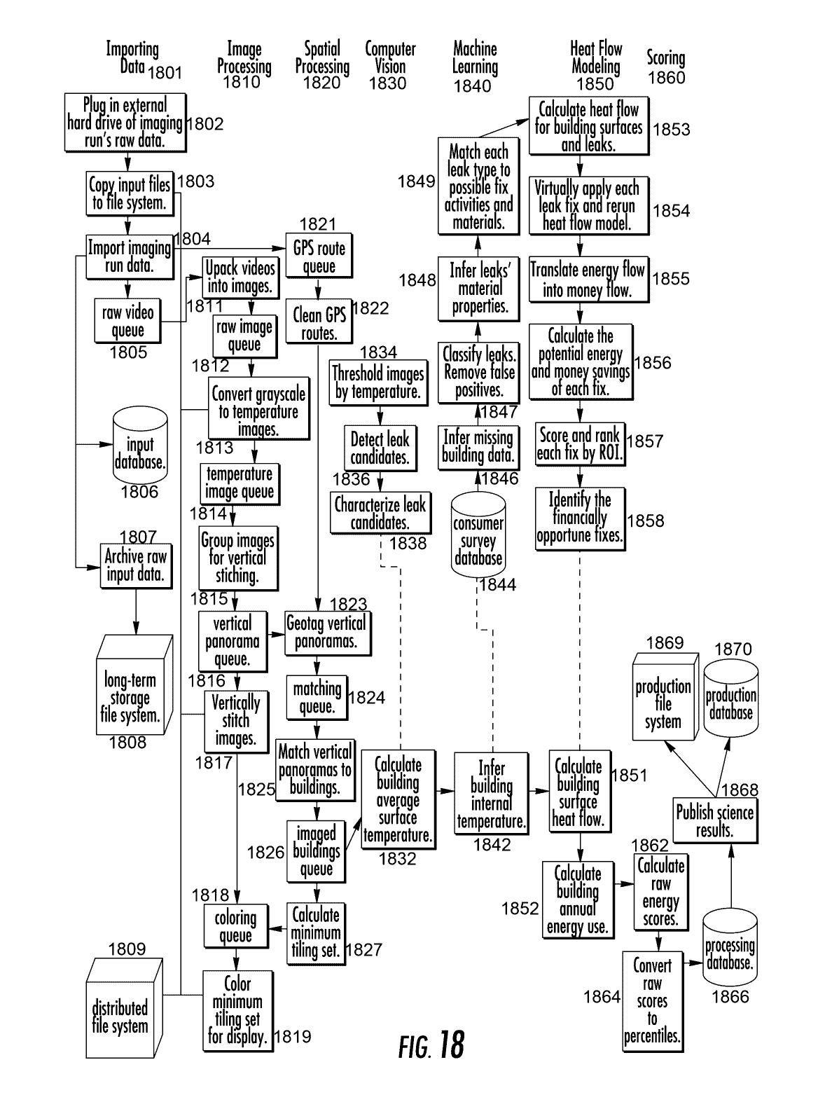

FIG. 18 shows an example embodiment of a workflow for processing image data in accordance with the present invention. Initially, data (e.g., image data, video data) is imported from an electronic data storage location 1801 into a system for image processing. Importing the data may comprise connecting an external hard drive 1802 containing the data into the system, copying 1803 the data into the system, importing 1804 imaging run data (including GPS, GIS, weather, and other data obtained concurrently with the image data) and obtaining the raw video images 1805. The imaging run data can be stored in an input database 1806 and the raw input data can be archived 1807 and ultimately stored in long-term file storage 1808. Once the files are imported, the images can be processed 1810. The images are processed by unpacking any videos into images 1811 to obtain a raw image queue 1812, converting grayscale images to temperature images 1813 to obtain a temperature image queue 1814, grouping images 1815 to obtain a vertical panorama queue 1816 for vertical stitching and vertically stitching images 1817. Spatial processing 1820 is then performed. Geolocation (e.g., GPS) data that is imported 1804 into the system is used to create a GPS route queue 1821, the GPS routes are cleaned 1822 by using additional data sources such as LIDAR data, IMU data, odometry data, and the like to smooth out the GPS lines. The cleaned GPS routes are used to geotag vertical panoramas 1823 which are provided in a matching queue 1824 and used to match vertical panoramas to buildings 1825. Matches are then placed in an image buildings queue 1826. Next, interconnected computer vision processes 1830, machine learning processes 1840, heat flow modeling 1850, and resultant scoring processes 1860 are initiated. From a given processed image, the average surface temperature of the building is calculated 1832 and an internal temperature of the building is inferred 1842. Next, the building surface heat flow is calculated 1851. The energy use of the building within a given time period (e.g., annual) is then calculated 1852. Such information is used to calculate a raw energy score 1862 that is a function of the energy use of the building with the given time period. The raw energy score is then converted to a percentile 1864. The percentiles and related information can be provided to a processing database 1866, and then processed to provide published science results 1868 which can be maintained in a production file system 1869 and corresponding production database 1870. The various files and data discussed above may be maintained in a distributed file system 1809.

The imaged buildings queue 1826 is used to calculate a minimum tiling set 1827 of images. The minimum tiling set 1827 together with the vertically stitched images 1817 are used to form a coloring queue 1818 consisting of sets of images sorted based on geography, time, and environmental conditions. These sets of images are then colorized 1819 using a parametric temperature-to-color mapping which is defined individually for each tiling set. Once colorized, the tiling sets are available for display.

A calculation of an average surface temperature of the building can be facilitated by determining threshold images by temperature 1834, detecting leak candidates 1836, and characterizing leak candidates 1838. Upon making an inference of an internal temperature of the building, a consumer survey database 1844 is accessed to, in sequence, i) infer missing building data 1846, ii) classify leaks and remove false positive 1847, iii) infer leaks' material properties 1848, iv) match each leak type to possible fix activities and materials 1849, v) calculate heat flow for building surfaces and leaks 1853, vi) virtually apply each leak fix and rerun heat flow model 1854, vii) translate energy flow into money flow 1855, viii) calculate the potential energy and money savings of each fix 1856, ix) score and rank each fix by ROI 1857, and x) identify the financially opportune fixes 1858. Such information can then be presented to the user as part of a report, as described elsewhere herein.

Reports, instructions, and guidelines may be provided in connection with the analysis and identification of energy leaks provided in accordance with the various embodiments of the present invention discussed above. Appendix A attached to the U.S. provisional patent application No. 62/173,038 filed on Jun. 9, 2015 (from which priority is claimed) includes a sample Report provided, for example, to a homeowner explaining the Thermal Analysis Program of the present invention, which is incorporated herein by reference in its entirety and for all purposes. The Report may include information, advice, and instructions regarding the thermal imaging process, the analysis provided, and possible remedial actions that can be taken to reduce or eliminate energy leakage. The Report may accompany or be provided separately from the thermal images, information, and/or assessments described above in connection with FIGS. 5-17.

The present invention also encompasses a method for calibrating and registering the various sets of images to ensure they can be analyzed contemporaneously and accurately using machines.

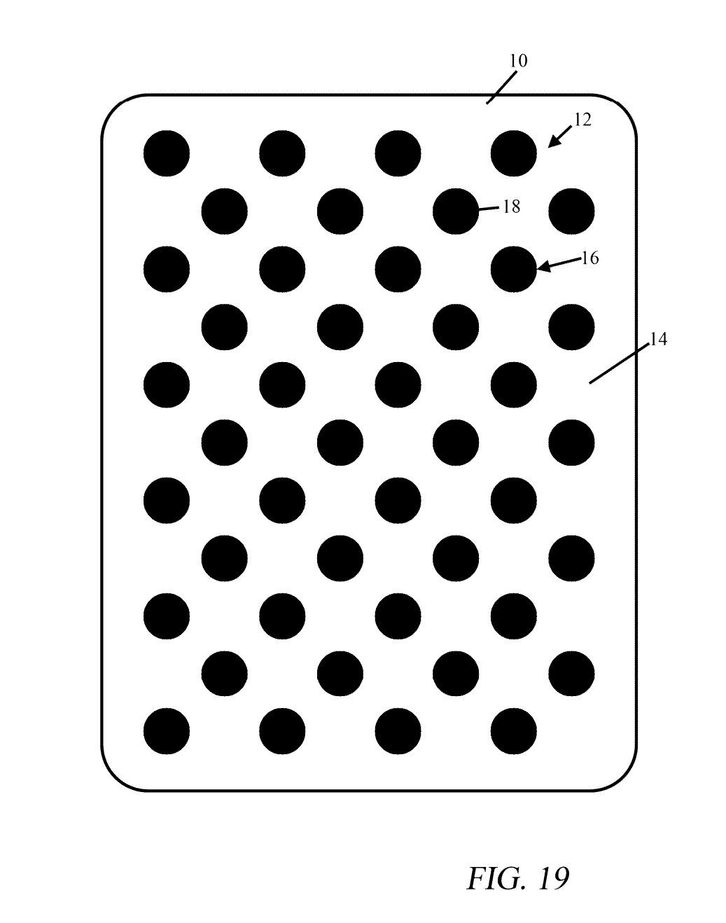

The present invention also encompasses methods for calibrating the image capture devices (cameras). An example embodiment of a calibration system of the present invention uses a calibration target with an asymmetrical circle pattern to simultaneously determine the parameters that describe the distortion in the thermal and near-infrared cameras. Additionally, because the pattern is observable in the visible, near-infrared and thermal spectrums, the system is also used to determine the relative position and orientation of multiple cameras. FIG. 19 shows an example embodiment of calibration target 10 with an asymmetrical circle pattern 12 provided in accordance with the present invention. The circle pattern 12 is visible in all three spectrums and forms an apriori defined set of geometric points and straight line segments in the physical space. Using standard mathematical transform techniques, these geometric patterns are compared against patterns extracted from each camera image to calculate calibration coefficients for each camera and the registration coefficients between the cameras. To provide the necessary multi-spectral image contrast (“visibility”), the calibration target 10 is constructed from several layers. The top layer 14 is a sheet of non-porous material with an asymmetrical circle pattern 12 of holes 16 cut out. The middle layer is constructed from a black sheet of felt 18 or other absorbent materials (visible through holes 16). The back sheet (not shown) provides structural integrity. Instead of heating the calibration target, the system uses evaporative cooling to provide a temperature differential visible by the thermal cameras. The cooling is performed by applying a liquid with a favorable vapor pressure such as Isopropyl alcohol (rubbing alcohol) to the felt circle 18, as the liquid evaporates it cools the felt circles 18 creating the temperature differential observable by the thermal camera. To make the pattern 12 visible in multiple spectra (e.g. visible, near-infrared and thermal) the outer layer 14 is made from an opaque white material and black felt 18 was chosen to provide high contrast. The pattern and colors are not critical as long as good contrast is provided. Other color combinations may be better suited for other applications. The circle pattern needs to provide high contrast for both near-infra-red and long wave infrared (thermal) cameras. The important aspect of the pattern is that it represents co-planar points on a grid. Other patterns (e.g. checkerboard) may be used. This combination of geometrical and material construction techniques allows for the registration of multiple camera images to form a multi-spectral image which can be analyzed in accordance with the techniques set forth herein.

It should now be appreciated that the present invention provides advantageous methods, apparatus, and systems for structural analysis of buildings and other objects, and providing useful information relating thereto.

Although the invention has been described in connection with various illustrated embodiments, numerous modifications and adaptations may be made thereto without departing from the spirit and scope of the invention as set forth in the claims.

What is claimed is:

1. A computerized method for analyzing a structure, comprising:
automatically capturing a plurality of images of a structure, the images being captured in one or more ranges of wavelengths of light;
processing the images to generate image data for the images; and
analyzing the image data to determine one or more properties of the structure;
wherein:
the images are captured at an angle with respect to the structure of between approximately 45 to 135 degrees; and
the images are captured during a time where one of indirect or no sunlight is present.

2. The method in accordance with claim 1, wherein the angle of the images is automatically determined and accounted for and the image data is normalized to account for solar radiation when generating the image data to provide accurate energy usage information and loss estimates.

3. The method in accordance with claim 1, wherein the images are captured using at least one image capture device mounted on a vehicle.

4. The method in accordance with claim 3, wherein the images are captured autonomously while the vehicle is in motion.

5. The method in accordance with claim 1, wherein:
the images are captured at a distance of between approximately 5 to 50 meters from the structure; and
the distance is automatically determined and accounted for when generating the image data.

6. The method in accordance with claim 5, wherein the images are captured using one or more different image capture devices from one or more different angles or distances.

7. The method in accordance with claim 1, wherein the one or more properties of the structure comprise at least one of a presence of the structure, a size of the structure, a shape of the structure or a portion of the structure, energy information of the structure, heating information of the structure, thermal energy leaks of the structure, structural, heating, and energy consumption information, energy flux per leak, a conductive, convective, and/or radiant heat flow of the structure or an area of the structure, and an energy consumption rate of the structure.

8. The method in accordance with claim 7, wherein the structural, heating, and energy consumption information includes one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof degradation, a presence of water damage, structural degradation, thermal emissivity, a presence or fitness of windows, a presence or fitness of roofing material, a presence or fitness of cladding, R-value, and wetness.

9. The method in accordance with claim 1, further comprising:
combining the image data with a separate set of data to form a corresponding combined data set;
wherein the analyzing is carried out on the combined data set.

10. The method in accordance with claim 9, wherein the separate set of data comprises one or more of public geographic information service (GIS) data, private GIS data, demographic data, self-reported homeowner information, manual energy audit information, weather information, climate condition information, energy usage information, contractor information, structural material information, property ownership information, location information, time and date information, imaging capture device information, global positioning system data, light detection and ranging (LIDAR) data, odometry data, vehicle speed data, orientation information, tax data, map data, utility data, humidity data, and temperature data.

11. The method in accordance with claim 1, wherein two or more of the images are stitched together to form multi-channel images.

12. The method in accordance with claim 1, wherein:
the one or more ranges of wavelengths of light comprise at least a first and a second range of wavelengths of light; and
at least a first set of the images is captured in the first range of wavelengths of light and a second set of the images is captured in the second range of wavelengths of light.

13. The method in accordance with claim 1, wherein the first and second sets of images are captured at different points in time.

14. The method in accordance with claim 1, further comprising:
calibrating one or more image capture devices used to capture the images;
wherein the calibrating comprises:
providing a calibration target with an asymmetrical circle pattern adapted for use in simultaneously determining parameters that describe distortion in thermal and near-infrared image capture devices; and
comparing patterns from the calibration target and patterns extracted from sample images to obtain calibration coefficients for each of the one or more image capture devices and to obtain registration coefficients between each of the one or more image capture devices.

15. The method in accordance with claim 14, wherein the calibration target is subject to evaporative cooling to provide a temperature differential visible by the image capture devices.

16. The method in accordance with claim 1, further comprising:
detecting at least one structural feature or component of the structure; and
performing at least one of conductive, convective, and radiant heat flow analysis of the at least one structural feature or component.

17. The method in accordance with claim 16, wherein the at least one structural feature or component comprises at least one of windows, doors, attics, soffits, surface materials, garages, chimneys, and foundations.

18. The method in accordance with claim 1, further comprising:
providing one or more reports comprising information pertaining to at least one of: energy consumption information for the structure; water damage; energy leaks; heat loss; air gaps; roof degradation; heating efficiency; cooling efficiency; structural defects; energy loss attributed to windows, doors, roof, foundation and walls; noise pollution; reduction of adulterants; reduction of energy usage and costs; costs of ownership; comparisons with neighboring or similar structures; comparison with prior analysis of the structure; safety; recommendations for repairs, remedial measures, and improvements to the structure; projected savings associated with the repairs, remedial measures, and improvements to the structure; offers, advertisements and incentives for making the repairs, remedial measures and improvements to the structure; insurability; and risk.

19. The method in accordance with claim 1, wherein:
the images are captured using at least one image capture device mounted on a vehicle;
the images are captured while the vehicle is in motion; and
a change in orientation of the vehicle or of the corresponding image capture device is automatically accounted for when generating the image data.

20. A system for analyzing a structure, comprising:
one or more image capture devices for automatically capturing a plurality of images of a structure, the images being captured in one or more ranges of wavelengths of light; and
a computer processor programmed for:
processing the images to generate image data for the images; and
analyzing the image data to determine one or more properties of the structure;
wherein:
the images are captured at an angle with respect to the structure of between approximately 45 to 135 degrees; and
the images are captured during a time where one of indirect or no sunlight is present.
